(19) United States
(12) Patent Application Publication
(10) Pub. No.: US 2025/0005378 A1
(43) Pub. Date: Jan. 2, 2025

(54) SYSTEM AND METHODS FOR TRAINING AND VALIDATION OF AN END-TO-END ARTIFICIALLY INTELLIGENT NEURAL NETWORK FOR AUTONOMOUS DRIVING AT SCALE

(71) Applicant: HYPRLabs, Inc., San Francisco, CA (US)

(72) Inventors: Tim Kentley-Klay, San Francisco, CA (US); Werner Duvaud, Neuilly-Sur-Seine (FR); Aurèle Hainaut, Paris (FR); Maxime Deloche, Montpellier (FR); Ludovic Carré, Paris (FR)

(73) Assignee: HYPRLabs, Inc., San Francisco, CA (US)

(21) Appl. No.: 18/759,880

(22) Filed: Jun. 29, 2024

Related U.S. Application Data
(60) Provisional application No. 63/524,213, filed on Jun. 29, 2023.

(51) Int. Cl. G06N 3/098; B60W 60/00; G06N 3/092

(52) U.S. Cl. CPC G06N 3/098; B60W 60/001; G06N 3/092

(57) ABSTRACT

The technology disclosed comprises systems and methods for the training and validation for an end-to-end neural-network learning model configured for autonomous driving. The end-to-end neural-network learning model is trained using human-operated driving demonstration data to curate training data examples of driving tasks and driving routes, as well as curation of particularly difficult driving tasks. The determination of difficulty of driving tasks uses a combination of entropy measurements in training, evaluation of model performance, and manual labeling. The conditional imitation learning model can be configured as a memory-augmented transformer model that leverages a memory-cached frame buffer to access previous states in a driving trajectory. The disclosed technology can be applied to passenger vehicles or autonomous robots for delivery tasks.

### CROSS-REFERENCE

This application claims the benefit of and priority to U.S. Provisional Application No. 63/524,213 filed 29 Jun. 2023, titled “Scalable Training and Validation For an End-To-End Autonomous Driving Model” (Atty. Docket No. HYPR 1001-1).

### RELATED CASES

This application is related to the following commonly owned applications which are incorporated by reference herein for all purposes.

U.S. patent Ser. No. 18/731,115, filed 31 May 2024, titled “System and Methods For Providing Driver Assistance Alerts Using an End-To-End Artificially Intelligent Collision Avoidance System and Advanced Driver Assistance Systems” (Atty. Docket No. HYPR 1002-1).

U. S CIP patent application Ser. No. ______, filed contemporaneously, titled “System and Methods For Providing Driver Assistance Alerts Using an End-To-End Artificially Intelligent Collision Avoidance System and Advanced Driver Assistance Systems” (Atty. Docket No. HYPR 1002-3).

U.S. patent application Ser. No. 18/431,827, filed 2 Feb. 2024, titled “Multi-Functional Inventory Storage and Delivery System” (Atty. Docket No. HYPR 1000-2) which claims priority to U.S. Provisional Application 63/443,342 filed 3 Feb. 2023, titled “Multi-Functional Inventory Storage and Delivery System” (Atty. Docket No. HYPR 1000-1).

### FIELD OF THE TECHNOLOGY DISCLOSED

The technology disclosed relates to end-to-end neural networks configured for autonomous driving. In particular, the technology disclosed relates to a scalable method and apparatus for training and validating an end-to-end network configured for autonomous driving.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the technology disclosed.

Autonomous driving technology has been of great interest to academia, industry, and public sector in recent years thanks to the advantages offered in both driver and rider satisfaction and safety. Vehicle automation can already be observed in today's market via the use of semi-automated systems such as advanced driver assistance systems and partially automated functions for a wide range of tasks including lane changing, speed control, and parking maneuvers. Automation of these tasks is highly desirable to drivers due to the increased convenience, assurance, and comfort while driving. Moreover, advancements to autonomous driving are beneficial to public safety, infrastructure, and vehicle longevity due to the potential reduction in number and severity of vehicle accidents offered by advanced driver assistance systems. Additionally, autonomous driving technology is highly relevant to a plethora of other robotic apparatuses and methods including space probes, industrial robot arms, military drones, and delivery robots. For example, the E-commerce industry can benefit from the use of autonomous delivery robots that bypass efficiency, cost, quality, and environmental pollution concerns addressed with traditional delivery methods.

Despite over forty years of research on autonomous vehicle development bolstered by advancements in artificial intelligence, computer vision, sensor technology, and network infrastructure, fully autonomous vehicles are not yet available for individual or commercial use on the market. The Society of Automotive Engineers defines six levels of driving automation ranging from zero (fully controlled by a human agent) to five (fully autonomously controlled). Although progress is substantial, safety and reliability performance is still lacking. Traditional autonomous driving systems, characterized by an aggregation of independent submodules responsible for individual tasks such as perception, localization, mapping, and path-planning, are challenging to optimize due to the complexity of the systems, requiring large teams of expensive engineers, often over 1000, and the enormous volume of data necessary to develop these systems which are sensor and compute heavy. Furthermore, the manual labelling of this data, or supervised learning, necessary for the artificial intelligence systems configured for traditional autonomous driving is expensive. Many data formats required by traditional autonomous driving systems, such as pre-built high-definition maps, are not only expensive to construct and label, but pose risks to safety and generalizability due to the limited capacity to react in situations where the real world environment does not correlate to the map as expected.

The drawbacks associated with traditional methodology which, while can be done come at enormous development expense and questionable scalability for mass production, have inspired focused research on development of an end-to-end (E2E) learning approach for autonomous driving. E2E strategies for autonomous driving typically consist of a single, self-contained deep learning model that maps sensory input, such as image frames from a camera or maps generated by radar or light detection and ranging (LiDAR), directly to steering wheel and accelerator/brake actuation for controlling the vehicle. Compared to the traditional autonomous driving system, E2E learning approaches are significantly more efficient to train using driving data that is more easily and affordably attained, such as human agent driver demonstrations or simulation data. E2E autonomous driving systems and methods are configured to learn from data via approaches such as reinforcement learning and imitation learning, rather than depending on an aggregation of manually-designed, computationally expensive, deterministic tasks written by experts. Successful training of an E2E autonomous driving approach using reinforcement learning and imitation learning must be capable of overcoming certain challenges such as the lack of a one-to-one data distribution between a ground truth human agent demonstration and a learned behavioral policy, varying quality of human agent driving actions, and the task of validating and testing the E2E model. In particular, scalability and achievement of regulatory safety standards are crucial.

An opportunity arises for the scalable training and validation of an E2E neural network configured for autonomous driving tasks. Such a system when validated, will be unsurpassable in performance, safety, energy efficiency and low cost of hardware with minimal power draw leading to true mass scaling of the technology, and the birth of the age of robotics.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a block diagram of components of an end-to-end autonomous driving system, in accordance with certain implementations of the present disclosure.

FIG. 2 is an architectural-level schematic of an end-to-end conditional imitation learning model for autonomous driving, in accordance with certain implementations of the present disclosure.

FIG. 3 illustrates an example of a plurality of possible driving states within a trajectory, in accordance with certain implementations of the present disclosure.

FIG. 4 illustrates an example of a plurality of possible driving trajectories within an environment, in accordance with certain implementations of the present disclosure.

FIG. 5 illustrates an example of a human agent demonstration of a driving trajectory and a clone agent imitation of the driving demonstration, in accordance with certain implementations of the present disclosure.

FIG. 6 illustrates an example of a human agent demonstration of a driving trajectory, as well as a mathematical model of an imitation learning framework associated with the driving trajectory, in accordance with certain implementations of the present disclosure.

FIG. 7 is an architectural-level schematic of an end-to-end conditional learning model for autonomous driving comprising a memory-augmented transformer, in accordance with certain implementations of the present disclosure.

FIG. 8 is an architectural-level diagram of a training system for an end-to-end conditional learning model for autonomous driving, in accordance with certain implementations of the present disclosure.

FIG. 9 is a block diagram of a training system for an autonomous driving neural network, as well as numerous examples of the computation of Shannon entropy and a cross entropy loss function, in accordance with certain implementations of the present disclosure.

FIG. 10 is a block diagram of a training system for an autonomous driving neural network, as well as a comparison of the computation of a cross entropy loss function and a focal loss function for the training system, in accordance with certain implementations of the present disclosure.

FIG. 11 is an architectural-level diagram of a validation system for an end-to-end conditional learning model for autonomous driving, in accordance with certain implementations of the present disclosure.

FIG. 12A is a block diagram of a training and validation system using trajectory feedback, in accordance with certain implementations of the present disclosure.

FIG. 12B is a block diagram of a training and validation system using state-action pair feedback, in accordance with certain implementations of the present disclosure.

FIG. 12C is a block diagram of an intervention learning system using corrective intervention from an online expert, in accordance with certain implementations of the present disclosure.

FIG. 12D is a block diagram of an intervention learning system using confounding intervention from an online expert, in accordance with certain implementations of the present disclosure.

FIG. 13 is a graph representing the optimization of a cross entropy loss function with and without a focusing parameter, in accordance with certain implementations of the present disclosure.

FIG. 14 is a block diagram of components of a hyper-local provisioning and delivery system including a depot and a plurality of transporters, in accordance with certain implementations of the present disclosure.

FIG. 15A illustrates an example of a transporter in a second extended or cruise position, in accordance with certain implementations of the present disclosure.

FIG. 15B illustrates another example of a transporter in a second extended position with a package secured on the transporter, in accordance with certain implementations of the present disclosure.

FIG. 15C illustrates an example of a transporter in a first extended position, in accordance with certain implementations of the present disclosure.

FIG. 15D illustrates an example of a transporter in a compact position, in accordance with certain implementations of the present disclosure.

FIG. 16 illustrates a computer system that can be used to implement the technology disclosed, in accordance with certain implementations of the present disclosure.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

### INTRODUCTION

Aspects of the systems, devices, and methods described herein provide a convenient and efficient approach to scalable training and validation of an E2E neural network for autonomous driving tasks. In particular, the technology described herein includes systems, devices, and methods for building a training data set for training an E2E neural network for autonomous driving tasks from at least a one-hundred thousand hours of operator-supervised driving data, and leveraging the data set to train an E2E conditional imitation learning model. The technology described herein further includes training an E2E neural network, such as a conditional imitation learning model, with confounded autonomous driving data such that the E2E learning approach is fine-tuned for responding to difficult (or entropic) situations, such as corner cases and edge cases, from at least a hundred hours of driving data. The disclosed technology is also described herein within the context of autonomous transporters, such as delivery robots, configured for autonomous delivery tasks.

Researchers within the academic, government, and industrial sectors have focused on the development of fully autonomous transportation for much of modern history. Far in advance of the invention of the automobile, historical inventors have constructed apparatuses for the mechanical automation of machinery, from early iterations of watermills and windmills to Leonardo da Vinci's self-propelled cart. It is, then, unsurprising that the effort to automate driving tasks followed closely behind the invention of the car. Early iterations of the self-driving car appeared in the early 20^{th} century and the advancement of autonomous driving technology exploded in response to technological advancements in robotics, cameras, sensors, network infrastructures, and particularly, with the rise of artificial intelligence. Autonomous driving advancements within the 21^{st} century thus far have been substantially driven by machine learning innovation and the application of machine learning to computer vision tasks.

Modern road vehicles frequently possess semi-automated functions and advanced driver assistance systems capable of automatically engaging braking systems in response to proximity sensing (e.g., collision systems paired to front- and rear-facing cameras coupled to the vehicle or blind-spot monitoring that leverages proximity sensors such as radar or LiDAR to prevent collisions during lane changes), steering control in response to lane drift, and dynamic cruise control systems that utilize a combination of accelerometer measurements and proximity sensing to control accelerator/brake actuation. More advanced automation of certain functions are increasingly recognizable, such as parking assist functionality capable of backing into parking spots or parallel parking, and “hands-on driving assistance” that enables semi-automation of steering wheel orientation and accelerator/brake actuation in response to an intended route (e.g., GPS directions) and environmental sensing systems coupled to the vehicle consisting of at least one camera, sensor, LiDAR, or radar.

There is a long felt need for autonomous driving systems. According to the American Automobile Association, the average American spends nearly three hundred hours in their car each year—the equivalent of more than seven full work weeks. In a fully automated vehicle, a driver would be able to reclaim all of that time for more productive or enjoyable activities. The innovations in accessibility offered by a fully-automated vehicle could potentially revolutionize freedom and independence for seniors, visually-impaired individuals, or mobility-impaired individuals. A transition from predominantly manually-operated vehicles to predominantly autonomously-operated vehicles (on a broad scale in terms of overall vehicles and a narrow scale in terms of individual vehicle functionality) may alleviate several sources of traffic congestion, such as sub-optimal and highly variable driving behaviors (e.g., improper compliance to merging and roadway entrance/exit guidelines by way of lane changing overly early/late or overly frequently/infrequently, unsafe or inconsistent distance between vehicles, or driver inattention) and collisions that block the roadway.

More importantly than traveler convenience, standardization and improvement of driving behaviors offer substantial safety benefit. The World Health Organization estimates that approximately 1.35 million people lose their lives in automobile accidents, and up to another 50 million people suffer automobile accident-related injuries, annually. Analysis of automobile accidents by the U.S. National Highway Traffic Safety Administration reveals evidence suggesting that up to 94% of serious accidents are due to risky driving and user error committed by drivers. Countless additional benefits exist ranging from a reduction in environmental concerns, insurance and maintenance costs, and social currency that appeals to drivers in thanks to technology and design appeal. Thus, it is unsurprising that improvement to autonomous driving systems is of great interest to automobile manufacturers, regulatory agencies, artificial intelligence and robotics engineers, academics, supply chain transportation and consumers.

Despite the combination of momentum, excitement, and advancement bolstering the autonomous driving technological advancement, a number of challenges still form tall barriers to overcome. Certain areas in particular are plagued by stagnancy despite overall growth—scalability of training and evaluation of autonomous driving systems, necessary safety improvements, cost efficiency (in terms of both time and monetary cost), and feasibility of implementation. The modern autonomous driving industry primarily encompasses two prominent strategies: so-called “traditional” autonomous driving systems and newly emerging end-to-end (E2E) learning approaches.

Traditional autonomous driving systems are characterized mainly by a plurality of distinct subcomponents that commonly consist of perception, localization/mapping, path planning, prediction and vehicle controls. The perception component involves the use of sensing with combinations of cameras, radar, LiDAR and infrared the environmental stimuli via the continuous observation and analysis of vehicle surroundings, to inform tasks such as obstacle detection, traffic sign recognition, lane marker detection, and proximity sensing. Along with the one or more perception components within a traditional autonomous driving system, localization/mapping components are configured to determine locations on a global and local scale (i.e., location in terms of a larger geographic map such as GPS coordinates as well as local orientation such as alignment within a lane and vehicle orientation) and often involve augmentation of map environment with sensor data for precision and accuracy. Outputs generated by perception and location/mapping systems may be fused to calculate optimal, safe intended paths and routes for the vehicle to drive by path planning systems. Optimally-planned paths, augmented by perception and location/mapping data, are processed by one or more decision-making components to drive action decisions for the control of vehicle actuators. Finally, vehicle control components are enabled by the above-described data to control actuation of vehicle machinery, such as steering and acceleration controls, to engage the vehicle in driving along the intended route. This pipeline involves hand written code, augmented with some ML models for semantics and prediction.

Traditional autonomous driving systems attempt to perform self-driving tasks through highly-specialized components working together cooperatively. However, substantial drawbacks have blunted the progress of implementing these complex systems. Principally high cost of development (in the billions of dollars per year) and high cost of system design and maintenance. These challenges remain, leaving the market to the most well financed developers, and at the same time, venerable to more effective developers who can do much more, with much less.

First, the training and validation of traditional approaches require massive volumes of training data, compounded by dozens of cameras, radars and LiDARs. This training data is exceedingly expensive, time-consuming, and complicated in process. Accordingly, the cleaning, labelling, and pre-processing of these data sets is equally demanding.

Second, and independent of the above-mentioned concerns, traditional autonomous driving systems typically heavily rely on static, pre-built data for use in deployment. For example, many path-planning and mapping models used in traditional autonomous driving systems utilize pre-built maps that are detailed and highly-accurate when prepared, but remain static and cannot be consistently relied upon to remain current with dynamic environments. Continuous updating of maps is time-intensive and problematic in practice at true scale. For instance, consider routes that are altered by construction, traffic congestion, collisions, or large events that re-route traffic. Thus, these methods are limited in their adaptive abilities.

These difficult problems have inspired the rise of E2E learning approaches for autonomous driving systems that have vastly less requirements for onboard computational power, cost, data accessibility, and reliance on historical data accuracy. An E2E learning approach is understood in the art to be a singular system, such as a deep learning classifier, that is configured to automatically process sensory inputs, such as camera images, and generate actions that control vehicle actuators such as steering and acceleration/braking. Performance quality of E2E autonomous driving models relies on the system's ability to map high-dimensional inputs to low-dimensional control signals. In spite of the advantages over a traditional approach, E2E learning-based strategies still require large-scale training and evaluation methods, generalizability, and robustness to a mismatch in the probability distribution underlying training data and test data, and ability to address difficult scenarios such as corner cases and edge cases.

The systems and methods disclosed herein include scalable approaches for conditional imitation learning of driving demonstrations resulting in E2E autonomous driving models capable of processing sensory data from a driving state or driving trajectory, mapping the state data to a predicted appropriate action, and performing the predicted action in order to execute a driving task. Technology disclosed include capturing from a fleet and curating a training dataset from at least a hundred-thousand hours of operator-supervised driving data to create a training set for an E2E neural network for autonomous driving tasks. For autonomous delivery by robots, as opposed to driving of vehicles, the technology disclosed can be applied training the E2E network for autonomous delivery tasks from at least one hundred hours of confounded autonomous driving data such that the E2E neural network is fine-tuned for avoidance of difficult driving situations and/or extrication from difficult driving situations. The technology disclosed can be applied as systems and methods to autonomously control a vehicle such as an automobile or truck driven on motorways. Alternatively, the technology disclosed can be applied as systems and methods are related to an autonomous transporter, such as a delivery robot, that can be configured to drive on motorways, sidewalks, or other real-space environments.

The discussion is organized as follows. First, a plurality of terms are defined and contextualized as described herein. Next, an overview of one implementation of a system configured for the initialization, optimization, and deployment of an E2E neural network for autonomous driving is described. Following the system overview, an architecture for an E2E neural network for autonomous driving is described within accordance of one implementation of the technology disclosed.

Imitation learning for autonomous driving, particularly focused on a plurality of implementations of conditional imitation learning models and their associated components disclosed, is introduced. Many implementations of a conditional imitation learning model for autonomous driving are described in further detail wherein the E2E model is a transformer. Specifically, a memory-augmented transformer is disclosed for certain implementations of the systems and methods described herein. Next, many implementations of the disclosed systems and methods for the training and validation of an E2E model for autonomous driving are introduced. In addition, selected performance results are described as objective indica of non-obviousness. A computer system that can be used to implement the technology disclosed, within accordance of one implementation, is also presented.

Finally, a number of particular implementations are listed in further detail.

### Terminology

A plurality of terms referenced herein will first be defined, as well as specifying analogous terms that may be used interchangeably and should be considered conceptually equivalent. The terms defined below (and terms derived therefrom) will be used in the present disclosure in the broadest meaning thereof.

The present disclosure relates to systems, apparatuses, and methods for end-to-end (E2E) learning approaches for autonomous driving. The present disclosure also relates to the training, validation, and other evaluation strategies such as fine-tuning and testing of an E2E learning approach. Models, systems, and methods described as E2E refer to a body of one or more learning approaches for a system, model, or stack, such as a neural network, configured to map one or more input value(s) to one or more output value(s). Specifically, the use of the term E2E contrasts the particular learning approach to a traditional autonomous driving system. A user skilled in the art will recognize the key similarities and differences between E2E approaches and traditional approaches for autonomous driving systems as well as their respective contexts and applications, and should be interpreted in the broadest definition thereof as such. The learning approaches described herein refer to machine learning systems and methods, such as a neural network. The neural network may comprise a plurality of architectures wherein the architecture is configured to process at least one data observation associated with a particular driving environment, driving state, or driving task to generate at least one data classification associated with a particular driving action, driving actuation, driving decision, driving path, or driving task.

The systems and methods disclosed herein may be applied to a plurality of robotic automation processes. Specifically, the implementations disclosed comprise a vehicle to be automated, wherein a vehicle is defined as a machine that transports people or cargo. The vehicle may be referred to synonymously as a “vehicle,” “automobile,” “car,” “machine,” “transporter,” “truck,” “motor vehicle,” “robot,” “van,” “cart,” and other forms of machinery configured for travel from one location in a space to a second location in the space, particularly machinery configured to transport cargo such as people, information, or goods. In some implementations, the vehicle is a motorized automobile such as a car, van, or truck. In other implementations, the vehicle is a robot transporter.

The vehicle operates within a particular environment, wherein the environment may be a real-world environment, a simulated environment, a virtual reality environment, an augmented reality environment, or a mixed reality environment. The environment comprises a space surrounding the vehicle, characteristics or features of the space, additional bodies or objects within the space, and in certain implementations, the vehicle itself and all agents and modules coupled to, or in control of, the vehicle. Within the environment, a plurality of trajectories are possible wherein a trajectory is defined by means of at least one state (referred to synonymously as an environmental state, a trajectory state or a driving state). Certain trajectories may also be defined by, or affected by, at least one action. In many implementations, a trajectory is a series of environmental states over time wherein each particular environmental state within the trajectory comprises a present condition of the environment at a particular time point and one or more components or features associated with the environment in the particular time point.

Herein, a time point may refer to an exact discrete point time (e.g., a specific one-dimensional data point specified in terms of days, hours, minutes, seconds, or other units of time such as 10 am, 0915, 00:00:30, Jan. 31, 2023 1:23 pm, or t=0) or a pre-defined acceptable window of time to allow for expected delays in response time or transmission of data (e.g., a state occurring at 9:30:15 am and an action occurring at 9:31:34 am may be respectively described as occurring at 9:30 am or respectively described as occurring at a particular tₜ within a time sequence T={t₁, t₂, . . . t_{T}}). Respective states within a particular trajectory may be described by their particular determined time point of occurrence, such as t₁, or as their ordering position within the trajectory, such as s₁.

For a particular state sₜ preceded by a state sₜ₋₁ and followed by a state sₜ₊₁, a transition function exists that maps an earlier state to a future state (e.g., from state sₜ to state sₜ₊₁, state sₜ₋₁ to state sₜ, or state sₜ₋₁ to state sₜ₊₁). The transition function is dependent on at least one feature of the environment, present state, or one or more future states. The transition function, in many implementations, is also dependent on a particular action, wherein an action is performed in response to a state. A task, frequently, can be described as a trajectory wherein actions are performed by a particular agent (e.g., an operator, driver, controller, teacher, human expert, model, clone, et cetera) in control of a particular machine (e.g., a body, a remote control, a vehicle, a cockpit, a bicycle, et cetera) to influence the state of the machine and the machine's interactions with the environment. As an illustrative example, consider a task performed as a particular trajectory comprising a plurality of states and actions in response to respective states, wherein each state may be responded to by a plurality of actions. The task, frequently, is performed by a particular agent (e.g., an operator, driver, controller, teacher, et cetera) in control of a particular machine (e.g., a body, a remote control, a vehicle, a cockpit, a bicycle, et cetera).

For an operator, or human agent, driving a car, an initial state s₀ can be characterized by the vehicle with the brake fully engaged by the operator and steering wheel in a neutral position of 0 such that the wheels are directed straight ahead. In response to the initial state s₀ the operator performs an action a₀ comprising removing their foot from the brake pedal such that the vehicle braking system is no longer engaged. The trajectory transitions to a state s₁ characterized by the vehicle gradually increasing velocity at a low acceleration rate, and the vehicle location changing in response. In response to state s₁, the operator performs an action a₁ comprising placing their foot on the gas pedal such that the vehicle velocity increases at a higher acceleration rate than previously. In turn, the trajectory transitions to a state s₂ characterized by the vehicle acceleration rate increases and the differential in vehicle location from s₂-s₁ is greater than that of the differential in vehicle location from s₁-s₀. In response to state s₂, the operator performs an action a₂ comprising adjusting the steering wheel orientation to an angle of −30 such that the vehicle begins changing its lateral location towards the left. As demonstrated by this example, the set of actions for a particular state at a particular time point A(sₜ) is determined by the features and conditions of state sₜ, and the set of possible states for a particular future state sₜ₊₁ is determined by the preceding action aₜ.

In addition to the feedback loop that occurs between the sequence of actions and states within a trajectory, additional variables influence the transition function. The set of possible future states following a present state within a trajectory may also be influenced by a changed environmental factor that was not changed by the agent action, such as the behavior of another driver, a pedestrian or animal, a machine failure, or a change in conditions such as the start or end of a rainstorm. The set of possible future actions following a present state within a trajectory may also be influenced by a factor external to the environment, such as a directive condition from a GPS. A directive condition may also be referred to synonymously herein as an intended route, a route instruction, a given direction, a goal destination, a route condition, or a similar terminology combining the above language or familiar language referring to directions given to a driver.

Within a particular environment, a plurality of trajectories exist. Trajectories may have overlapping and non-overlapping segments, such that certain states and/or actions are shared despite non-overlapping states/and or actions that precede the overlap. For a first example, consider a state characterized by a car arriving at a specific destination defined by a street address. A first car and a second car may arrive at the same state despite non-overlapping trajectories prior to converging. For a second example, consider an identical pair of a first and a second sequence of actions that begin at non-identical states. A third car and a fourth car are likely to arrive at different final states despite overlapping actions. For a first example, consider a fifth car and a six car beginning on an identical trajectory comprising identical states and actions for a set number of time points tₙ, until a time point tₙ₊₁ wherein the fifth car and sixth car are controlled by non-overlapping actions, at which point the trajectories diverge. A first trajectory and second trajectory may converge and diverge a limitless number of times, wherein the convergence and divergence may occur as a result of a limitless number of trajectories.

Within many of the implementations disclosed, states are described by input from at least one camera, a set of non-camera environmental data such as a location, intended path, prior trajectory information, two-dimensional or three-dimensional mapping data, radar, LiDAR, and/or sensor data, a velocity vector of travel, steering wheel orientation, and/or actuation from the accelerator/brake, gear shift, or additional driving mode control system. Additionally, actions may be described in terms of steering wheel orientation/first derivative of the steering wheel orientations/second derivative of the steering wheel orientations, accelerator or brake actuation/first derivative of the accelerator or brake actuation/second derivative of the accelerator or brake actuation. A user skilled in the art that a large number of additional descriptors exist both for a state of a driving environment and a driving action, respectively. Thus, these descriptors, such as gear shifting, forward/reverse direction, traffic congestion, inertia, wheel rotation or balancing, tire pressure, vehicle condition status, turn signal actuation, et cetera, will be omitted to improve the clarity of the description.

An environment described in terms of trajectories comprising sequential states and actions is described using certain mathematical language for the purpose of disclosing particular imitation learning implementations of the technology described herein. However, it is to be understood that multiple additional mathematical models and frameworks exist for similar purposes using differing terminology, additional parameters, or alternative representations of relationships between certain features/descriptors and other features/descriptors, such as transformations, mappings, functions, or covariances. Similar to the above statement, these alternative mathematical models are omitted to improve the clarity of the description. However, certain implementations further comprise additional parameters or modifications as necessary such as a coordinate input representation or trajectory integration within the data representation of a model input or output, or a parameterization of a function such as the transition function between an earlier and a later state.

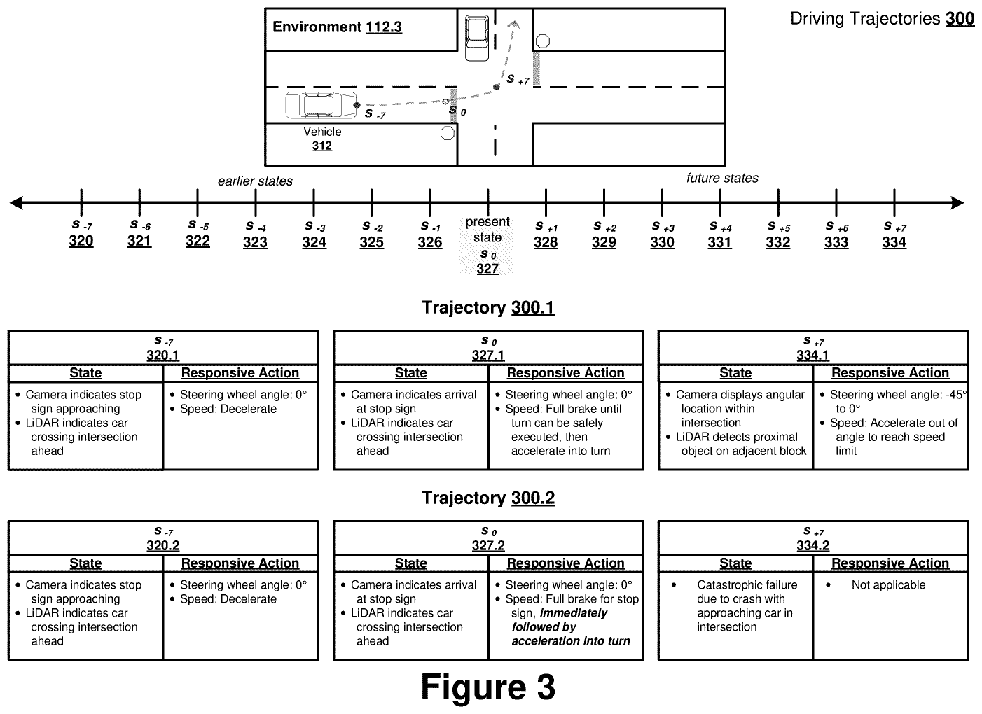

The terminology employed herein with regard to environments and trajectories is chosen thereof for the purpose of clearly introducing the imitation learning approach of the technology disclosed. Further elaboration of the imitation learning approach disclosed begins at FIG. 3. Herein, the learning approaches leveraged by the disclosed model may be referred to as reinforcement learning, imitation learning, behavioral cloning, reverse imitation learning, adversarial imitation learning, or apprenticeship learning. The implementations described in detail herein for the purpose of description primarily focus on a conditional imitation learning approach; however, it is to be understood that the model disclosed is configured such that a number of implementations are possible with minimal modifications that do not significantly change the spirit or scope of the disclosed systems and methods. For example, implementations introduced wherein learning is performed offline such that the model does not have access to expert feedback are easily adjusted to implementations wherein learning is performed online with access to expert feedback. As a second example, the disclosed systems and methods are applicable to a training method wherein the model is optimized to minimize the loss between a human agent action and a model predicted action, or to minimize the loss between a human agent behavioral policy and a modeled behavioral policy. The differences between these implementations are minor; therefore, highly similar implementations with differing reinforcement learning strategies will not be contrasted in detail for the sake of redundancy.

The imitation learning and reinforcement learning approaches described herein with reference to particular implementations of the technology disclosed relate to a number of probability distributions, some of which are conditional probability distributions such that the probability of a variable taking a particular value or state is computed given a condition (i.e., the probability of an event A given an event B, or P(A|B) such as the probability of a vehicle hitting a pothole given a particular steering wheel orientation). Although many probability distributions, and conditional probability distributions, are presented, within the context of the disclosed conditional imitation learning model, the imitation learning approach is termed “conditional imitation learning” with specific reference to an additional driving condition given as input to the model such as a GPS direction, intended route, speed limit, or goal destination (e.g., the probability of a specific state mapping to a specific action given a conditional instruction to remain on an intended route).

When training examples of trajectories are introduced herein, the term “demonstration” may be used synonymously to describe a particular trajectory, a particular trajectory segment, a particular transition from a first state to a second state, or a particular action, each respectively performed by an expert (i.e., one or more human agents, simulation agents, or clone agents wherein the behavior of the agent is the behavior to be emulated by the autonomous driving model). In the broadest definition, a demonstration associated with the disclosed technology should be understood as a set of at least one driving state and/or action included as a training example within a training dataset for use in a reinforcement learning or imitation learning system or method.

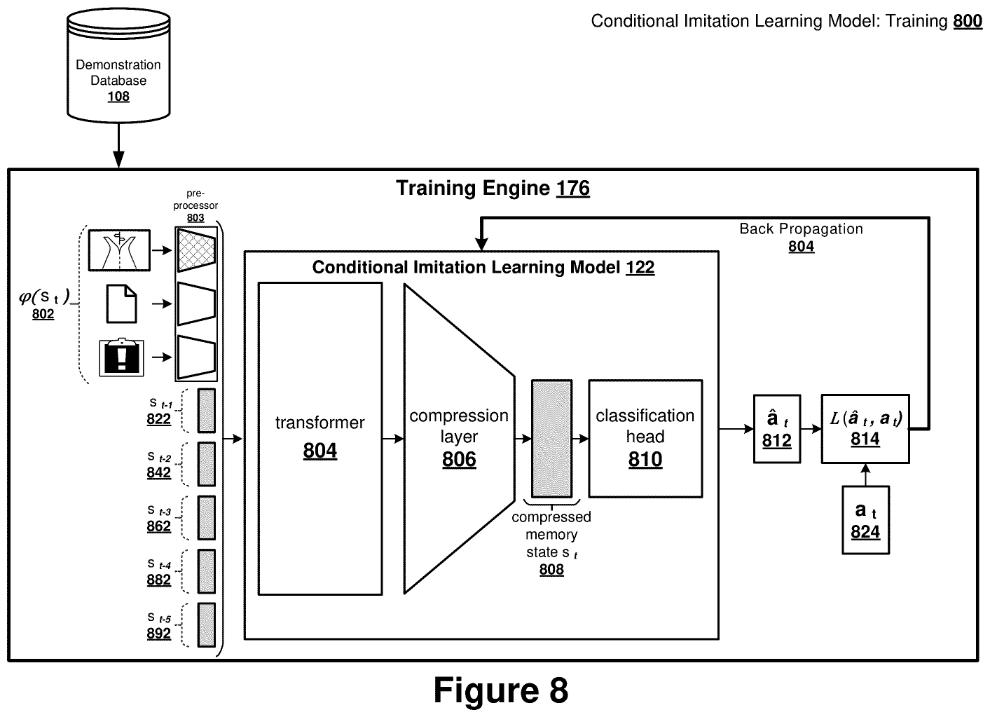

During training processes, described in more detail beginning with FIG. 8, all combinations of the set of all possible actions accompanying each state A(S) and all possible states S within a particular environment, wherein the codomain is within [0, 1], is described as the policy set, or π. The policy set (synonymous with policy, behavioral policy, (behavioral) policy distribution, or (behavioral) policy function) is frequently described in terms of a probability distribution, such that the behavioral policy π is the probability distribution over the set of all possible actions, given the set of all possible states. Herein, the behavioral policy may also be referred to in an abbreviated manner as the probability distribution over actions given states, or simply as the mapping of states to actions.

The behavioral policy of an expert, intuitively, is a representation of the logical strategy used by the agent in pursuit of a goal. For illustrative purposes, consider the process of a human agent first learning to drive. As the driver improves, she becomes better equipped to handle previously unseen situations, or react accordingly to her driving environment without needing to perform a memorized sequence of actions. Generally speaking, this phenomenon is possible due to the driver embracing a general set of rules or guidelines that dictate all of her driving decisions in a way that patterns can be tracked, regardless of environment. Examples of these rules may include reducing vehicle speed as the driver approaches an intersection with a traffic light so that she can prevent sudden braking out of necessity if the light changes unexpectedly, or her strategy for reducing speed at a steady rate on an exit ramp to prevent slowing down too soon and needing to accelerate again to reach the approaching traffic light or not slowing down soon enough so that a sudden braking is necessary once reaching the traffic light. In situations such as these selected examples, the driver does not need to memorize specific actions in response to her exact environment or trajectory, or even a fully- or almost fully-comprehensive set of characteristics specific to her exact environment or trajectory. Given a learned pattern in response to at least one characteristic cue from her driving environment, the driver is able to accurately predict the appropriate action in response to her present driving state. This learned pattern is the driver's behavioral policy, and an autonomous driving model can be trained to learn the driver's behavioral policy.

In contrast, autonomous driving models can also learn to directly imitate, or clone, the driver's behavior without attempting to approximate a driving policy. Further implementations may comprise off-policy learning, wherein a mapping function from a state to an action can be learned without attempting to learn a particular policy. However, in many situations, it is advantageous to learn a behavioral policy that enables the autonomous driving model to respond to previously unseen scenarios.

A technological challenge in autonomous driving systems addressed by the present disclosure is the ability of an autonomous driving model to generalize to previously unseen scenarios. In certain cases comprising certain familiar characteristics, or lacking certain unfamiliar characteristics, this may not be a difficult task for the model. However, in other cases, certain automation models perform quite poorly. Thus, it is important to train, validate, fine-tune, and/or otherwise thoroughly evaluate the automation model for cases that may potentially be difficult to predict an appropriate reaction in response to.

In addition to the language described above within the context of mathematical models, such as the transition of states in response to actions within a trajectory, the present disclosure may also refer to certain driving scenarios, demonstrations, or driving predictions in synonymous terms of a driving “task,” “situation,” “scenario,” or “case.” These terms do not directly correlate to one specific state, trajectory, actions, or segment of a trajectory. In contrast, a driving task may consist of a range of actions and detail. In some examples, a driving task comprises a single action or a small number of actions, which may or may not be particular to a specific driving state or characteristic(s) identifiable within a driving state, such as a maneuvering task to extricate a vehicle from a particularly suboptimal position or unsafe scenario such as a tight parking spot or approaching a large, potentially detrimental piece of debris in the road. A driving task may be even smaller in magnitude, such as the reaction time necessary to prevent rear-ending another vehicle when approaching a sudden and unexpected stop on the highway in response to a collision ahead or quickly reacting to a pierced tire to prevent further wheel damage. A driving task may be even larger in magnitude, such as completing a trajectory in extreme weather conditions such as a blizzard or flood. Thus, the above terms such as driving tasks, scenarios, or cases are left intentionally broad to encompass a broad range of driving states and actions that is not limited by a particular length of time, extent of action, or type of action.

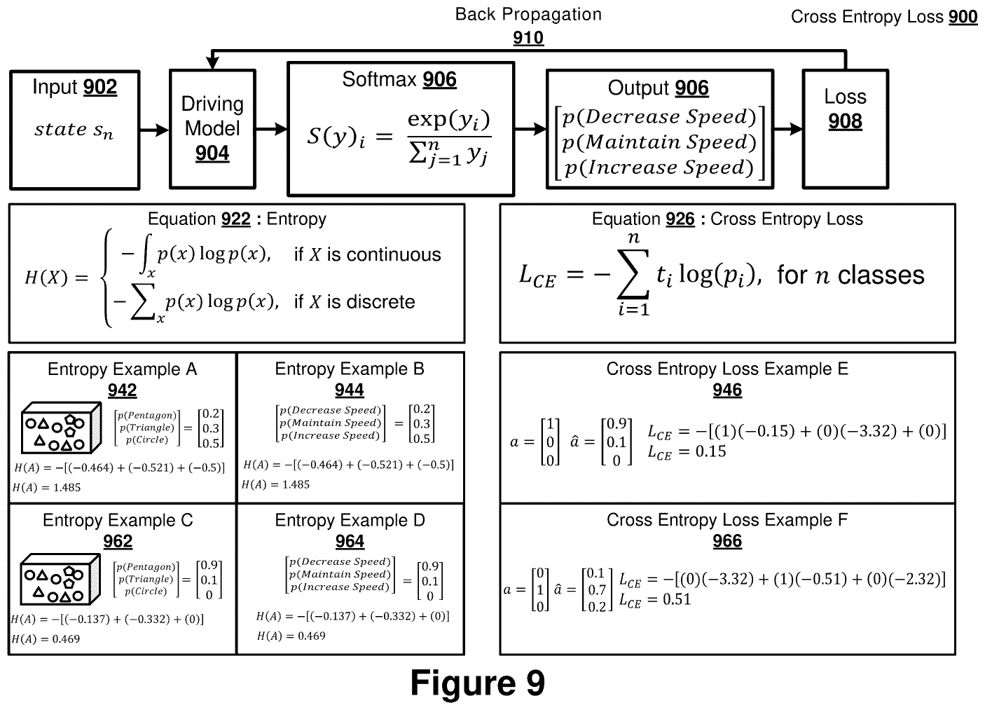

These difficult cases may be synonymously referred to as an “entropic case,” wherein the term entropic is a description of the high entropy state of a particular probability distribution or uncertainty of a particular prediction. Implementations comprising entropy calculations and related concepts are further expanded upon beginning with the description of FIG. 9. Some of the difficult cases to be learned will be corner cases. A corner case is a rare or unexpected scenario that occur very infrequently while driving. As a result, it is difficult to obtain training data observations containing corner cases. Examples of corner cases include encounters with black ice, malfunctioning traffic lights, or sudden interactions with other drivers performing suboptimal behaviors (e.g., when a driver encounters a green light but must suddenly stop to prevent a collision with another car running a red light to cross the intersection ahead of the driver).

Difficult cases to be learned also include edge cases. Certain edge cases are well established, such as certain weather conditions such as snowy weather causing highly variable road traction, heavy rain that blocks camera systems, and thick fog distorting camera or sensor observations. Glare and direct sun also can give rise to edge cases. Other edge cases may be difficult to predict until data is obtained demonstrating a particular scenario. Certain edge cases may be more difficult for a human agent than others, including some driving scenarios that are simultaneously edge cases and corner cases. Other cases may be corner cases but not edge cases, such as scenarios with well-defined rules, yet nonetheless provide specific challenges to humans, like starting and stopping with an appropriate response time in congested traffic. Yet other cases may be edge cases but not corner cases, such as driving directly into the sun such that the brightness is tolerable to the human eye but disabling to a camera or light-based sensor.

Unless stated otherwise, the above definitions, usage, and context are relevant as applicable to the below description. Additionally, certain language choice, concepts, or frameworks may be additionally expanded upon below and/or defined differently for a particular context as necessary.

The above aspects of the present disclosure will now be expanded upon further, beginning with an overview of a system of the technology disclosed, within accordance of certain respective implementations of the present disclosure.

### System Overview

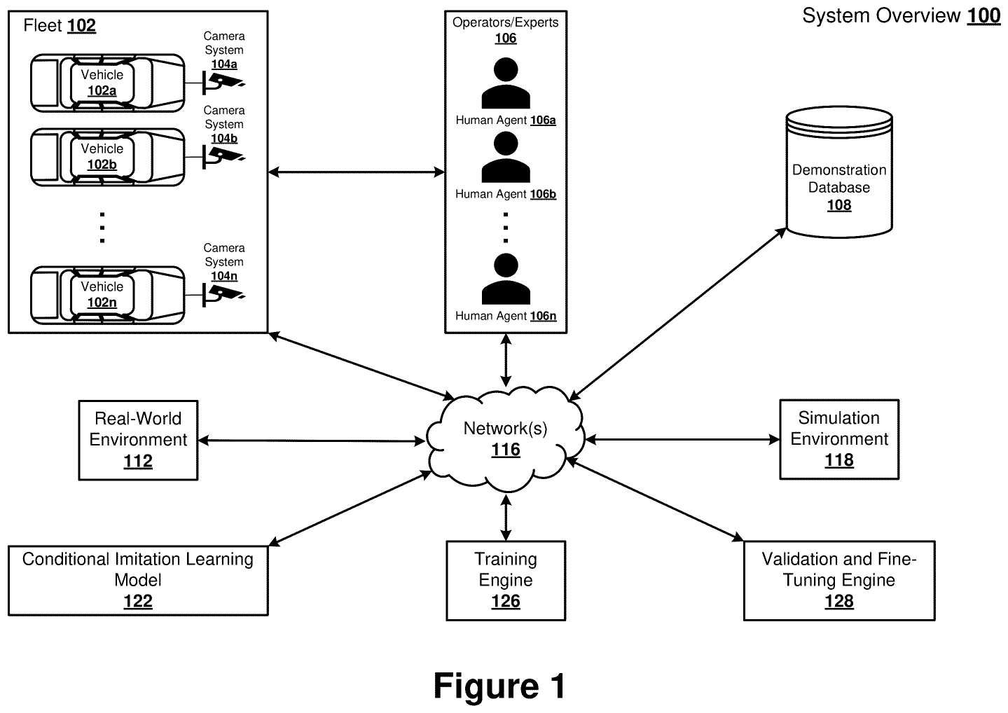

A system and various implementations of the technology disclosed are described with reference to FIGS. 1-16. Certain system and processes are described with reference to FIG. 1, a block diagram of an autonomous driving system in accordance with certain implementations. Because FIG. 1 is an architectural diagram, certain details are omitted to improve the clarity of the description.

The discussion of FIG. 1 is organized as follows. First, the elements of the system are described, followed by their interconnections. Then, the use of the elements in the system is described in greater detail.

FIG. 1 is a block diagram of components of an end-to-end autonomous driving system, in accordance with certain implementations of the present disclosure. The system 100 includes a fleet of vehicles 102, further including n total vehicles 102a, 102b, . . . , through 102n. Each vehicle is respectively coupled to a camera system 104, such as camera system 104a coupled to vehicle 102a. Each respective camera system within the n total camera systems 104n further includes at least one camera and additional hardware technology to record information about the current vehicle environment. The additional hardware may include, but is not limited to, at least one radar, LiDAR, sensor, accelerometer, communication system, two-dimensional or three-dimensional mapping device, location tracking device, audio recorder, tire and/or brake status monitoring system, thermometer, retinal tracker and/or an additional driving control actuator. The system 100 further includes a number of operators and experts 106, comprising n total human agents 106a, 106b, . . . , through 106n. The system also includes a demonstration database 108, a simulation environment 118, a real-world environment 112, a conditional imitation learning model 122, a training engine 126, and a validation and fine-tuning engine 128.

The engines, environments, and models included as subcomponents of system 100 may be considered analogous to a network node in certain implementations of the present disclosure. As used herein, a network node is an addressable hardware device or virtual device that is attached to network(s) 116, and is capable of sending, receiving, or forwarding information over a communications channel to or from other network nodes, including channels using TCP/IP sockets for example. Examples of electronic devices which can be deployed as hardware network nodes having media access layer addresses, and supporting one or more network layer addresses, include all varieties of computers, workstations, laptop computers, handheld computers, and smartphones. Network nodes can be implemented in a cloud-based server system. More than one virtual device configured as a network node can be implemented using a single physical device.

For the sake of clarity, only one subcomponent of each category is shown in the system 100. However, any number of network nodes hosting each respective subcomponent can be connected through the network(s) 116. The system components of system 100 (in addition to other processing engines described herein) can execute using more than one network node in a distributed architecture.

The interconnection of the elements of system 100 will now be described. The network(s) 116 connect the disclosed conditional imitation learning model 112 to the training engine 126 and the validation and fine-tuning engine 128, demonstration database 108 and additional datasets described within the present disclosure, data obtained from, and related to, the real world environment 112 and the simulation environment 118, as well as vehicles within the respective environments within the fleet 102.

The fleet 102, wherein a particular vehicle 102n within fleet 102 may be a motor vehicle (e.g., a car, van, or truck) or a robot (e.g., a rolling delivery robot or motorized transporter) can be controlled directly or indirectly by the plurality of operators and experts 106. Motor vehicle operators are on board. Transporters are too small to carry operators, so they may walk alongside delivery robots. Operators and experts 106 utilize the fleet 102 to collect driving data via the camera systems 104a through 104n and other hardware devices. In some implementations of the technology disclosed, vehicle 102n is coupled to a number of recording devices respective to the internal control of the vehicle 102n (not illustrated) and the external environment that vehicle 102n exists within. To improve the clarity of the description, a limited number of hardware devices are included within the description of the present disclosure that may omit additional hardware devices utilized within many implementations of the disclosed technology. Implementations represented within FIGS. 1-16 include internal control recording devices for accelerator/brake actuation and steering wheel orientation and their respective control execution by a driver during operation.

Recording devices and additional hardware coupled to vehicle 102n involved within the represented implementations can include varying combinations and constructions of at least one camera system 104n configured for obtaining images and video streams of the surrounding environment, a sensor system, a location and positioning system, and an accelerometer system. The camera system 104n may include one or many cameras positioned on various locations of the vehicle, such as front-facing cameras, rear-view cameras, or 360° camera configurations. The sensor system may include one or more sensors configured for obtaining data characterizing surrounding three-dimensional surfaces, object proximity, and/or motion detection. In many implementations, the location and positioning system is a global navigation satellite system (GNSS, or “satnav”), but can also comprise radio-frequency/network communication tracking systems such as 5G or ultra-wideband communication. The accelerometer system, for example, can be a g-force measuring sensor configured to measure g-force in three-dimensions, enabling tracking of speed, impact, vibration, inclination, and/or other forms of strain and shock forces.

Data collection from vehicles 102a through 102n within fleet 102 may be analyzed and processed for aggregation into a dataset such as a demonstration database 108, wherein the transmission and storage of data is mediated by the network(s) 116. The demonstration database 108 and related datasets can comprise a range of data structure organization. During a driving session, the driving environment contains the driving route, surrounding space along the route, features and characteristics of the space (e.g., road condition, traffic congestion, weather, location of intersections, speed limits, road curvature, et cetera), other objects and individuals within the space (e.g., other vehicles, pedestrians, road debris, animals, and physical structures), interactions with other objects and individuals, as well as the vehicle itself and the operator of the vehicle. Within a driving environment, the vehicle interacts with a variety of circumstances along the route. At any given point in time or space, the environment can be described as a state. The state can be described by a number of features, wherein a feature may characterize a particular object/actor/task or an interaction between one or more objects, actors, or tasks. A state may correspond to differing lengths of time or areas of space. For example, stopping at a red light and waiting for the light to turn green can be a single driving state that takes place in a single location but may last anywhere from a period of milliseconds to a period of minutes. In contrast, losing traction on ice and unintentionally sliding laterally may be a very short period of time, experienced as “instantaneous” by an operator, but take place across different locations and orientations due to the slide. Typically, states are considered transitional series in a sequence, such that a present state is preceded by an earlier state and followed by a future state.

The transition of a state to another state, defined more specifically in later sections, may be influenced by a variety of features corresponding to the current state, one or more previous states, change in features across states, interactions with other objects within the environment, or actions executed by the operator. Temporarily disregarding factors that influence transitions between states outside of a driver's control, it is possible to model the transition from one state to another as a function of an operator action. For example, the sequence of states within a driving task may take on drastically different patterns depending on whether or not the steering wheel orientation is turned ninety degrees counterclockwise, or kept in a neutral position facing forward. Intuitively, the relationship between states and actions within a driving environment more closely resemble a feedback loop rather than a unidirectional cause-and-effect function. A change in state such as the change of a light from green to red, slowing speed of vehicles ahead, or sudden environmental changes like a deer crossing the road must illicit an action from a driver in response to the state transition for safety and comfortability of the driving conditions. Thus, it is important to consider the local and global positional relationships between states in a sequence, as well as the relationships between states and actions. Actions may also be examined independent of states while analyzing driving data. For example, a driver may adjust their control of the accelerator to speed up or slow down the vehicle (sequential relationships between actions), or simultaneously control the brakes and steering wheel to park the vehicle (concurrent relationships between cooperative actions).

Various forms of data collected during the operation of vehicles 102a through 102n can be synchronized using timestamping. Timestamping processes may use exact alignment methods (depending on the degree of precision within the recording intervals), aggregation methods (i.e., combining all data within a particular window such as five seconds, thirty seconds, or one minute), or context-informed alignment methods allowing for a cause-and-effect relationship between driving conditions and operator responses. Particularly, the pairing between certain features or characteristics within a driving scenario and the decisions an operator executes via operation of one or more vehicle actuators is highly informative for driving pattern recognition. Accordingly, the synchronization of driving data may not directly align with precise time-stamping.

Consider the previous example of a driver sitting at a red traffic light, then engaging the accelerator to move the vehicle forward in response to the change of the traffic light to green. The first state (a red light) transitions to a second state (a green light), and in response, the driver chooses to execute an action that will cause the vehicle to move. However, the driver is not likely to make this action in the same exact point in time that the green light appears. There may be cars ahead of the driver, requiring a waiting period to allow safe distance before accelerating. Even if the driver is operating the closest vehicle to the light, varying response time is to be expected. Furthermore, requiring precise synchronization in certain scenarios will result in large volumes of stagnant and uninformative data that negatively affect data usage. In a dataset containing state and action observation data paired second-by-second, the traffic light example would contain a very small proportion of behavioral pattern data as compared to a large proportion of stagnant, identical data observations. It is likely to be more efficient and helpful for many analyses of the traffic light example to pair a red light appearance state to a braking action, a red light waiting state to a maintenance action (i.e., the decision to not change conditions yet, in and of itself, can be an important behavior to properly time actions) and a green light appearance state to an accelerating action. Thus, in many driving behavioral analyses, the reactionary and synergistic relationships between states and actions is of greater interest than highly-precise time synchronization.

Driving tasks and routes may be segmented into smaller units containing distinct states and actions (or continuous transitions across states and actions) for analytical purposes. Conversely, states and actions may also be concatenated into larger units, such as trajectories, for analytical purposes. A trajectory may refer to a particular driving task (such as turning or parking), a particular segment of a driving route (such as a portion of the route occurring on the interstate from an entrance ramp until an exit ramp), or an entire route from starting location to ending location. In the context of statistical models and artificial intelligence systems for autonomous driving, different data structures and segmentation strategies may be employed to achieve different learning goals. Datasets containing more complex tasks such as the completion of an intended route can be better suited to learn a behavioral policy for responding to spontaneous environmental stimuli, whereas datasets containing simpler tasks such as parking scenarios can be informative for fine-tuning vehicle maneuvering. Both types of datasets may be extracted from a vehicle 102n in fleet 102 to be used as demonstrations by human agent 106n in demonstration database 108. In addition to demonstrations performed by operators/experts 106 in the real-world environment 112, simulated data created by operators/experts 106 and synthetic data may also be virtually obtained within a simulation environment 118.

The collected data within demonstration database 108 can be used by training engine 126, as well as validation and fine-tuning engine 128, for the training and optimization of the conditional imitation learning model 122. Conditional imitation learning model 122 is an end-to-end deep learning model for autonomous driving. Different implementations of conditional imitation learning model 122 leverage variations of reinforcement learning approaches in combination with deep learning architectures to learn safe and efficient driving methods and apply learned driving behavioral patterns and techniques to autonomously operate some or all functionality of a vehicle without the intervention of a human operator.

The technology disclosed presents a method for end-to-end deep learning for autonomous driving, as well as scalable training and validation strategies for end-to-end autonomous driving models that address safety, evaluation, and generalizability challenges associated with autonomous driving technology. These challenges will briefly be summarized in the following section, followed by an overview of the architectural features and functionality of the disclosed technology configured to address the summarized challenges.

### End-to-End Imitation Learning Model for Autonomous Driving

Despite the resources, funding, and public interest focused on the development of autonomous vehicles, fully-autonomous driving technology is yet to exist in a format that meets safety and feasibility requirements for deployment. Technical advancements have resulted in a range of semi-automated driving technology achievements. These achievements possess varying accuracy and reliability, such as the safety features for lane-assist and collision-prevention systems that have become commonplace in modern vehicles and controversial semi-automated driving functions that allow a driver to partially relinquish steering and acceleration decisions to their vehicle. Autonomous driving technology still faces considerable barriers, however, in the areas of scalability and safety. As defined by the SAE, the extent of driving automation applicable to vehicles are:
Level 0—No automation and fully-manually controlled by a human
Level 1—Vehicle features a single automated system, such as a cruise control function
Level 2—Partial automation by advanced driver assistance systems for tasks such as steering and acceleration, wherein partially-automated tasks are fully monitored by the driver, who may intervene at any time
Level 3—Conditional automation engaged in response to appropriate environmental factor detection, with some human override involved
Level 4—High automation level characterized by full driving automation that a driver can still override when necessary
Level 5—Full autonomous control of the vehicle under all conditions with zero human control involved

While rare examples exist of Level 3 and Level 4 autonomous vehicles, mainstream production for consumer use has not surpassed Level 2 at the time of this disclosure. Further advancements in safety and reliability must be demonstrated to further progress.

Safety standards applied to the functionality and performance of autonomous vehicles are primarily directed by the American National Standards Institute (ANSI) and ISO standards from the International Organization for Standardization.

Evaluation of autonomous products, including vehicles, utilizes the ANSI/UL 4600 standard for safety. ANSI/UL 4600, the first widely-adopted safety standard applied towards autonomous vehicle operation, evaluates fully autonomous products operating independently of human supervision. ANSI/UL 4600 establishes broad, technology neutral guidelines for safety in terms of risk analysis, data integrity, autonomy validation, life cycle resiliency, and conformance assessment. In contrast, ISO standards such as ISO 26262, ISO 21488, and ISO/SAE 21434 define requirements specific to autonomous vehicle technology safety. ISO 26262 evaluates functional safety of electrical/electronic systems in vehicles, particularly safety management in the event of a system malfunction or failure. ISO 21488 covers the safety of the intended functionality (SOTIF), which addresses unintended behavior of systems in absence of an ISO 26262 system malfunction. ISO/SAE 21434 covers cybersecurity risk management at stages ranging from concept design, development and manufacturing processes, operation, maintenance, and decommissioning of road vehicles.

A primary obstacle blocking the satisfactory compliance of autonomous vehicles to the above-described safety standards is scaling. For an autonomous vehicle to be adequately safe, reliable, and generalizable to complex and dynamic driving landscapes, a large volume of data is necessary. While data availability limitations are not exclusively responsible for all remaining technical gaps, data need is intimately connected to all aspects of autonomous driving system development. Areas of technology under improvement that are related to autonomous vehicles, for instance, computer vision and sensor development, are limited in their growth potential without available data to learn from that is sufficient in both magnitude and variety. Moreover, additional technical scalability dilemmas related to time, cost, and resources cannot be addressed without the information at hand to do so.

Both traditional autonomous driving technologies and end-to-end learning approaches rely heavily on artificial intelligence and deep learning systems that evaluate the environment, predict future changes to the environment, and make decisions in response to the environment. The development of robust, generalizable deep learning models capable of learning complex feature spaces and patterns is highly dependent on rich data for training, validation, fine-tuning, and further evaluation/testing processes.

The autonomous driving systems and methods described in the present disclosure address this issue, in part, via the use of an E2E approach. The E2E architecture of the disclosed systems improves scalability by reducing the dependency on up-to-date, highly complex map data and is configured to process driving conditions not previously seen during training. Using E2E approaches is substantially more efficient in terms of data usage and computational cost, in part, due to the configuration of the deep learning model to extract useful features directly from input data and converting input data processing directly into driving actuation.

However, scalability concerns are not fully addressed by the improvements offered by implementing an E2E approach. It is still necessary to acquire enough data for both learning and validation processes that provides sufficient training for rare and difficult scenarios. Corner cases such as extreme weather, close proximity to collisions, and spontaneous road blockages by pedestrians or stray objects are rare occurrences that are difficult to obtain sufficient amounts of training data for, but these scenarios are also crucial for autonomous driving models to learn due to their significant safety risk and potential consequence if handled poorly. In addition to the obvious ethical importance, safety standards such as the SOTIF guidelines within ISO 21448 substantially focus on the evaluation of risk level in response to hazardous events.

In contrast to corner cases, which generally refer to rare and potentially hazardous driving scenarios, care must also be taken to ensure that a model is sufficiently capable of handling edge cases. Edge cases, although frequently overlapping with corner cases, address conditions that may introduce unique challenges to computational systems as compared to human drivers. Autonomous vehicles may respond poorly to edge cases, for example, due to limitations in computer vision technology or highly-individualized scenarios. While situations like heavy rain or a busy elementary school child pick-up lane can often be stressful or challenging for a human driver, the complexity is intensified for an autonomous driving model without sufficient generalization of learned driving behavior representations.

The difficulty of training an autonomous driving model that is not only familiar with an adequately diverse range of driving scenarios, but also generalizable to scenarios that are unfamiliar, can be addressed using reinforcement learning and imitation learning approaches. By leveraging driving demonstrations performed by human drivers, it is possible to train an autonomous driving model, like the E2E system disclosed herein, to learn feature distributions, feature patterns, and overall behavioral policy, therefore enabling the model to process driving scenarios and determine a plan of best action in response to input data from the environment that does not depend on previous exposure specific to the scenario, location, or route.

The disclosed systems and methods provide a solution to scalability and performance challenges by combining the advantages of E2E learning and imitation learning strategies with additional deep learning methodology that enables context-aware learning and scalable approaches for data collection, training, validation, and further useful learning tools such as fine-tuning and transfer learning to prepare the model for a wider breadth of driving scenarios. Next, the architecture of the disclosed E2E model, in accordance with some implementations of the technology disclosed, is introduced, followed by the expansion upon training and validation strategies for the disclosed E2E model.

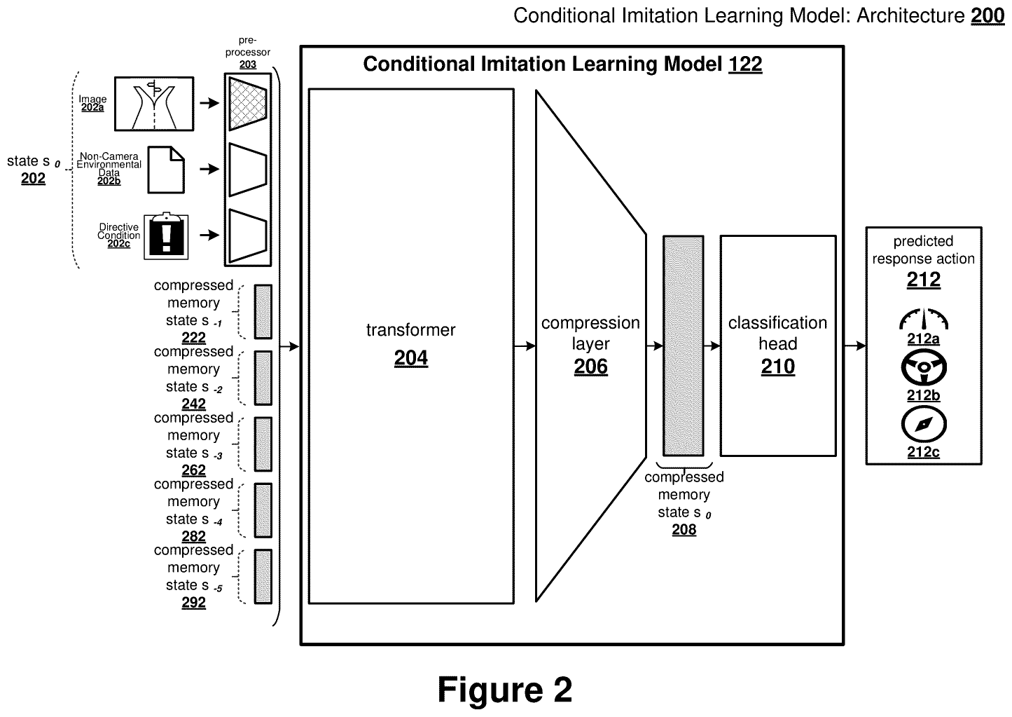

FIG. 2 is an architectural-level schematic 200 of an end-to-end conditional imitation learning model 122 for autonomous driving, in accordance with certain implementations of the present disclosure. Conditional imitation learning model 122 is illustrated within schematic 200 in accordance with one exemplary implementation of the technology disclosed comprising a transformer architecture. At a high level, the conditional imitation learning model 122 processes environmental data corresponding to a state s₀ 202 within a driving environment to predict an appropriate response action 212, executing operation of one or more actuators controlling a vehicle. Input state s₀ 202 is represented by observations including an image 202a and a plurality of non-camera environmental data 202b (e.g., sensor and GNSS data). In addition to the observations describing state s₀ 202, a directive condition 202c (e.g., a GPS-direction guiding a vehicle along an intended route) is also provided. In other words, conditional imitation learning model 122 predicts an action in response to a state, based on a condition restricting the vehicle's driving trajectory. The conditional route may refer to a route directing the vehicle to a specific target end location, or a shorter-term conditional route such as the next three, five, or ten seconds of intended routes. In some implementations, the route is based on a static target end location. In other implementations, the target end location may be dynamic and shift in response to previous route progress.

In addition to the data corresponding to the present state s₀ 202, memory data in a compressed format is extracted from storage in a frame buffer containing information corresponding to a number of prior states in the given trajectory. For simplicity and clarity, schematic 200 illustrates a total of five previous memory frames—compressed memory state s₋₁222, compressed memory state s₋₂242, compressed memory state s₋₃262, compressed memory state s₋₄ 282, and compressed memory state s₋₅ 292. However, in many implementations of the technology, more than five previous memory frames are stored in the frame buffer for use as input to the present state such as ten, fifteen, twenty or a larger number of previous memory frames. These memory frames may cover two, three, five or more seconds of history at frame rate lower than standard video capture. A memory frame refers to a “snapshot” or latent representation of previous states processed by conditional imitation learning model 122, wherein the generation and storage of compressed memory states into the frame buffer is elaborated upon further later in the discussion of the transformer architecture. As previously described, the segmentation of driving state data into states within a trajectory is variable. In certain implementations of the technology disclosed, the number of states corresponds to at least three seconds of history preceding the present state s₀ 202.

Prior to the second processing stage performed by conditional imitation learning model 122, observation data for state s₀ 202 undergoes pre-processing in a first stage processor stage by pre-processor module 203. Pre-processor 203 respectively embeds the input data from image 202a, non-camera environmental data 202b, and directive condition 202c. In some implementations, image 202a undergoes image processing that is unique to the deep learning analysis of image data, as indicated by the hashed-line shading of the unit within pre-processor 203 adjacent to image 202a. In certain implementations, this image processing is performed by a convolutional neural network. In one implementation, the processing model responsible for pre-processing data contained in image 202a is a pre-trained module that has been transferred or fine-tuned for use in conjunction with conditional imitation learning model 122. Next, the processing stack comprising conditional imitation learning model 122 processes the embedded outputs from pre-processor 203 along with the compressed memory states 222, 242, 262, 282, and 292 using a transformer 204 and compression layer 206. This second stage processor of the illustrated processing stack produces the memory frame for input state s₀ 202. In other words, the output of compression layer 206 is a compressed memory state 208 of input state s₀202. Compressed memory state s₀208 will be stored within the frame buffer using a FIFO (first in, first out) storage process such that at the time of processing a state s₁, the frame buffer will include compressed memory representations 208, 222, 242, 262, and 282 respective to states so, s₋₁, s₋₂, s₋₃, and s₋₄.

To generate the predicted response action 212 in response to input state s₀ 202, compressed memory state s₀208 is processed in the third stage processor by a classification head 210 to generate the final predicted action 212. Specifically, the compressed memory states₀208 is processed to produce actuation of the steering wheel and accelerator/brakes that can change the speed 212a, orientation 212b, and thus, location 212c of the vehicle.

Additionally, in many implementations, the collected data within demonstration database 108 and/or further data obtained in relation to the trained conditional imitation learning model 122 (e.g., data extracted from demonstrations, training trajectories, statistical analysis of driving data from either a human agent or an autonomous driving agent, and so on) may be used to implement additional advanced driver assistance systems within an autonomous or semi-autonomous vehicle. In certain implementations, an advanced driver assistance system configured to act as a collision avoidance system can be designed to emit a warning signal (an audible and/or visual notification) to a human agent operating a vehicle in response to a predicted dangerous driving state being detected. In one implementation, the detection of a potential danger by the conditional imitation learning model 122 (or a separate trained model that is associated with conditional imitation learning model 122) is performed in response to the processing of an operator action such as a lack of contact with the steering wheel, an interaction with the accelerator/brake actuator(s) that deviates from an expected velocity or acceleration, or a retinal tracking pattern that indicates distracted driving. In another implementation, the detection of a potential danger by the conditional imitation learning model 122 (or a separate trained model that is associated with conditional imitation learning model 122) is performed in response to the processing of a feature of one or more driving states, such as an object detected in close-proximity or rapidly-approaching proximity to the vehicle, a changing traffic signal, or a lane deviation. In many implementations, the detection of a potential danger during driving is informed by a combination of both driving states and operator actions, and data that is associated with a present driving state/action, one or more previous driving states/actions, or a differential change in a feature associated with one or more driving states/actions.

In some implementations, the advanced driver assistance systems configured via data collection, learning, and statistical analyses performed in association with the methods and systems disclosed herein may be implemented within a semi-autonomous vehicle to instigate the transition of manual control to autonomous control or vice-versa. In one example, an advanced driver assistance system, such as an automated emergency breaking response, may be configured to respond to a predicted collision (i.e., in response to an object in close proximity to the vehicle or a lack of response from an operator to a traffic signal) by overriding manual control of the vehicle and initiating automated breaking. In another example, a so-called “adaptive cruise control” system may be configured to respond to a vehicle exceeding a pre-defined allowable threshold for object proximity (e.g., a pre-defined distance allowed between the operator's vehicle and a separate vehicle directly in front of the operator's vehicle such as a minimum distance between vehicles of thirty feet, fifteen meters, or two car-lengths) or for speed (e.g., a pre-defined speed limit for the vehicle such as eighty miles-per-hour, seven miles-per-hour over the presently-detected speed limit, or a ten percent increase in speed over the presently-detected speed limit).

In a third example, a risk detection system for autonomous driving mode may be configured to detect a certain operator action (e.g., lack of contact with the steering wheel for a pre-defined time limit, such as five, thirty, or sixty seconds, or a manual override input such as an operator interaction with the brake actuator) or a certain feature of the driving state (e.g., weather conditions that decrease the computer vision quality of a vehicle camera or sensor or an unexpected change to a known road, such as construction) and respond to the detected trigger by signaling to the operator that they must transition to manual driving mode to prevent the vehicle from identifying a safe stopping point and ending the route. In many example implementations, the advanced driver assistance system may provide a range of statistical analyses performed on the driving behavior of the vehicle, independent of the extent to which the vehicle is autonomously-operated, towards the operator regarding the current performance and behavior of the vehicle that can be useful for the operator in terms of driving behavior, safety warnings and feedback, or potentially-necessary vehicle maintenance. This data that can be provided to the vehicle operator, such as a distracted driving metric, detected vehicle system malfunction, or suggested adjustments to vehicle settings, can be more informative than typical driving data presented towards an operator in thanks to the high-dimensional, high-volume data collected within demonstration database 108 and the potential information depth achievable during learning by the conditional imitation learning model 122.

In the above-described example implementations, as well as a number of further scenarios to which a user skilled in the art would recognize an advanced driver assistance system could be implemented within the technology disclosed herein, an advanced driver assistance system may leverage driving demonstration data from both human agents and autonomous driving agents, as well as any associated analyses, used in training, validation, fine-tuning, or transfer learning. The advanced driver assistance system may also leverage pattern recognition and risk analysis data extracted from a trained autonomous driving model, as well as external data input by further expert feedback and/or computational analysis of data extracted from the trained autonomous driving model. Furthermore, the advanced driver assistance system may also leverage data and data analysis obtained from driving trajectories performed after model deployment, whereby the autonomous vehicle continues to collect and monitor data from an operator while the vehicle is operated using a trained autonomous driving model to either present data towards the operator and/or continue fine-tuning the model for frequent scenarios encountered by the vehicle. For example, two drivers may both obtain a respective autonomous vehicle initially comprising an identical autonomous driving model (e.g., the same trained conditional imitation learning model 122 with the same parameters). However, over time, as the first driver continues using the autonomous vehicle in a first driving environment profile (for example, predominantly shorter drives on suburban surface streets) and the second driver continues using the autonomous vehicle in a second driving environment profile (for example, predominantly long distance freeway drives), both the conditional imitation learning model 122 and any associated advanced driver assistance systems can be fine-tuned to address the respective situation-dependent needs of each driver and their non-overlapping driving environment profiles.

To establish a foundation in accordance with certain implementations of the training and validation processes disclosed herein, an imitation learning framework will now be described in further detail.

### Imitation Learning for Autonomous Driving

FIG. 3 illustrates an example 300 of a plurality of possible driving states within a trajectory, in accordance with certain implementations of the present disclosure. Example 300 occurs within the context of a driving environment 112.3 existing within the real-world environment 112. Driving environment 112.3 includes a particular layout of roadways with various orientations and relevant legal guidelines for use of the roadways, structures and objects surrounding the roadways, weather and atmospheric conditions, other vehicles, pedestrians, and a vehicle 312. Vehicle 312 is driving along a particular route that can be described in terms of a trajectory. An infinite number of possible trajectories exist within environment 112 equivalent to the total combination and permutation of possible routes that can be taken within the environment, each of which has the potential to be infinitely long. The actualized trajectory taken by vehicle 312 can be described by a sequence of states, represented by the illustrated number line.

The illustrated number line centers on a present state s₀ 327. Present state s₀ 327 was preceded by a sequence of earlier states including state s₋₁ 326, state s₋₂ 325, states₋₃ 324, state s₋₄0.323, state s₋₅ 322, state s₋₆ 321, and state s₋₇ 320. Present state s₀ 327 will be succeeded by a sequence of future states including state s₊₁ 328, state s₊₂ 329, state s₊₃ 330, state s₊₄ 331, state s₊₅ 332, state s₊₆ 333, and state s₊₇ 334. The trajectory of vehicle 312 is also illustrated within the schematic of environment 112.3 by the grey, dashed arrow indicating that vehicle 312 indicates to turn left at the approaching intersection. As shown within the schematic of environment 112.3, vehicle 312 is in a position approaching a stop sign at state s₋₇ 320 and reaches the stop sign at the present state s₀ 327. If the future states are carried out as intended, vehicle will be mid-execution of a left turn and positioned in the middle of the illustrated intersection at state s₊₇ 334.

However, the intersection at which the turn is to be performed is complicated by a number of factors. While vehicle 312 encounters a stop sign at the present state s₀ 327, vehicles traveling through the illustrated intersection from the cross-street do not have a stop sign and may drive straight through. As a result of the legal guidelines, vehicle 312 is not only expected to abide by the stop sign and reach a complete stop at the present state s₀ 327, vehicle 312 is also expected to yield to crossing vehicles and remain fully stopped at the stop sign until there is sufficient clearance to safely initiate the left turn to avoid a collision.

Two trajectories are described within example 300, trajectory 300.1 and trajectory 300.2. In trajectory 300.1, a representative sample of trajectory-specific states is described with reference to an earlier state s₋₇ 320.1, the present state s₀ 327.1, and a future state s₊₇334.1. At state s₋₇ 320.1, sensors coupled to vehicle 312 (for example, a camera system as described for system component 104) indicate that a stop sign is approaching and LiDAR measurements detect the approaching vehicle from the left via proximity sensing. In response, the operator does not execute any actions that change the steering wheel angle from the neutral position of 0° but interaction with the accelerator/brake pedals is adjusted such that deceleration results. Herein, steering wheel orientation will be described in reference to angular measurements where 0° indicates that the wheels are exactly parallel to the vehicle, driving the car forward (or, directly backwards if the car is shifted to reverse gear). Rotation of the steering wheel clockwise to orient the wheels towards the right will be described in terms of positive degrees, such as +45°. Rotation of the steering wheel clockwise to orient the wheels towards the left will be described in terms of negative degrees, such as −45°. However, in various implementations, steering need not be represented in this numerical format and may comprise alternative formatting and scaling. In certain implementations, training data will further include information about the operator's eye movements using retinal tracking data.

At the present state s₀ 327.1 of trajectory 300.1, vehicle 312 has approached the boundary indicating the appropriate position to stop in compliance with the stop sign. At state s₋₀ 327.1, the camera system coupled to vehicle 312 indicates that the front end of the car has reached the stop sign and LiDAR proximity measurements indicate that the crossing vehicle is now directly in front of vehicle 312 as it crosses the intersection along the cross street, roughly perpendicular to vehicle 312. As a result, the operator of vehicle 312 the operator does not execute any actions that change the steering wheel angle from the neutral position of 0°, nor does the operator begin to accelerate out of a full stop until after the crossing vehicle has passed and the turn can be safely executed. When vehicle 312 reaches future state s₊₇ 334.1, the state observations obtained by the vehicle include camera recognition of the angled location of the vehicle within the intersection while mid-turn and LiDAR proximity sensing of various structural objects present on the adjacent block to which the car will pass on its turn. To perform the driving task of a left turn, the operator has turned the steering wheel counterclockwise, measured at approximately −45 at the time of future state s₊₇ 334.1, mid transition back to 0 to straighten out the vehicle by the end of the turn to orient the vehicle parallel with the road upon completion of the turn. Similarly, the operator also begins to accelerate out of their turn to approach the speed limit respective to the new road.

As stated above, there are infinite trajectories possible within environment 112.3 in addition to trajectory 300.1. Furthermore, trajectories are not pre-destined. As a trajectory transitions from a first state sₜ into a new state sₜ₊₁, there exists a set of the total number of actions possible in response to state sₜ₊₁. The selection of an action is a variable in the determination of the state transition and resulting state sₜ₊₂. Accordingly, trajectories 300.1 and 300.2 are not guaranteed to continue overlapping solely because they began with overlapping states and actions. As an extension, it is possible for trajectories to converge or diverge from one another at any state or any point in time.

In trajectory 300.2, a representative sample of trajectory-specific states is described with reference to an earlier state s₋₇ 320.2, the present state s₀ 327.2, and a future state s₊₇ 334.2. At state s₋₇ 320.2, the state and action are the same as those within state s₋₇ 320.1 (trajectory 300.1), so the details will not be stated redundantly here. Hence, the present state s₀ 327.2 is characterized by the same state observations as the present state s₀ 327.2 regarding the camera and LiDAR detection of the vehicle's location at the stop sign and proximity to the crossing vehicle. However, trajectory 300.2 diverges from trajectory 300.1 at state s₀ 327.2. The operator does comply with the stop sign at state s₀ 327.2 as indicated by the full brake in the responsive action. In contrast to trajectory 300.1, however, at state s₀ 327.2, the operator of the vehicle 312 fails to appropriately comply with guidelines for ordering of turns at the intersection and does not wait for the crossing vehicle to safely clear the intersection prior to executing their turn.

In response to the action of the operator at state s₀327.2, the vehicle 312 collides with the crossing vehicle within the intersection at some point following state s₀ 327.2, resulting in catastrophic failure that prematurely ends the trajectory. As such, trajectory 300.2 will not reach a future state that is seven steps ahead of state s₀ 327.2 and no action can possibly occur at a state s₊₇ 334.2.

However, actions resulting in catastrophic failure are not the only cause of divergence in trajectories. Within example 300, both trajectories share the same intended route, driving task, and share the same goal. Trajectories 300.1 and 300.2 differ in quality and success of execution. Frequently, trajectories may converge then diverge but continue on. Alternatively, conditional imitation learning model 122 may be trained to clone the behavior of the operator within trajectory 300.1 with the goal of successfully emulating the manner in which the operator demonstrates safe yielding prior to entering the intersection. Conditional imitation learning model 122 also could be trained with reinforcement learning methods using trajectory 300.1 as a positive example, wherein similarity to the actions within trajectory 300.1 is rewarded, and using trajectory 300.2 as a negative example, wherein similarity to the actions within trajectory 300.1 is penalized. Applying any alternative training, conditional imitation learning model 122 could successfully grasp the turning safety behavior taught by example 300.

These training processes, depending on additional training data used, may or may not generalize well to other scenarios. If the trained model encounters a left turn under different circumstances (e.g., an intersection with a traffic light or a crossing pedestrian) or must perform a different driving task, conditional imitation learning model 122 should also learn from additional driving demonstrations.

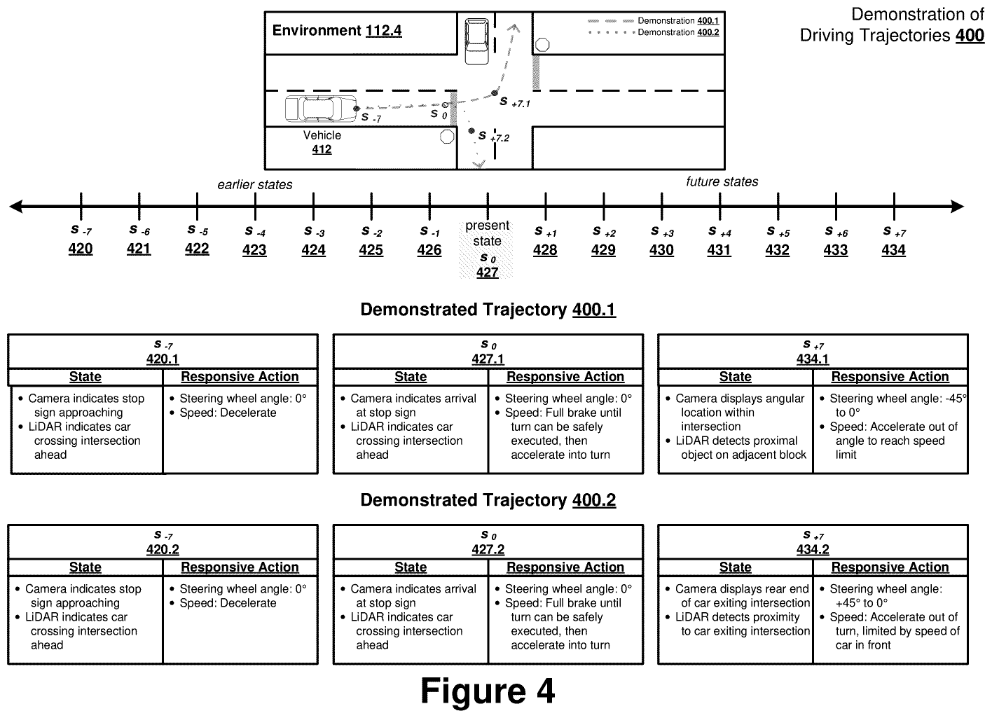

FIG. 4 illustrates an example 400 of a plurality of possible driving trajectories within an environment, in accordance with certain implementations of the present disclosure. As in example 300, example 400 involves an environment 112.4 characterized by a distribution of potential trajectories, each including a sequence of driving states. The same ordering format is used, such that a trajectory transitions across a sequence of earlier states including state s₋₁ 426, state s₋₂ 425, state s₋₃ 424, state s₋₄ 423, state s₋₅ 422, state s₋₆ 421, and state s₋₇ 420, a present state s₀ 427, and a sequence of future states including state s₊₁ 428, state s₊₂ 429, state s₊₃ 430, state s₊₄ 431, state s₊₅432, state s₊₆ 433, and state s₊₇ 434. Within the schematic illustrating environment 112.4, vehicle 412 is placed in the same scenario as vehicle 312. Vehicle 412 approaches a stop sign at an intersection where a car is crossing from the intersecting street on the driver's left. A first possible trajectory 400.1 of vehicle 412 is illustrated within the schematic of environment 112.4 by a grey, dashed arrow indicating that vehicle 412 indicates to turn left at the approaching intersection. A second possible trajectory 400.2 of vehicle 412 is illustrated within the schematic of environment 112.4 by a grey, dotted arrow indicating that vehicle 412 indicates to turn right at the approaching intersection.

Both trajectories 400.1 and 400.2 are demonstrated by an expert operator with driving state and operator action data being collected for the trajectory. Trajectory 400.1, described at a previous state s₋₇ 420.1, a present state s₀ 427.1, and a future state s₊₇ 434.1 are described. Within trajectory 400.1, the expert operator executes an identical series of actions in response to an identical series of states as seen within trajectory 300.1, and so the details are not repeated here to avoid redundancy. In contrast to example 300, the demonstration data in example 400 exhibits multiple potential future trajectories following present state s₀ 427 with two nonoverlapping, safely executed actions that diverge into different routes. Within trajectory 400.2, the expert operator executes an identical series of actions in response to an identical series of states as seen within trajectory 300.1 and 400.1 up to reaching a present state s₀ 427.1, so again, the details will not be restated. However, the goal of trajectory 400.1 is to turn right at the intersection, instead of left. The operator of vehicle 412 still waits for the other vehicle to safely clear the intersection before accelerating into their turn. The schematic illustrating environment 112.4 contrasts the respective locations of s₊₇ 434.1 (marked as s_{+7.1}) and s₊₇434.2 (marked as s_{+7.2}). By the time the operator of vehicle 412 reaches state s₊₇ 434.2 within trajectory 400.2, state observations from the camera and LiDAR indicate that vehicle 412 is now directly behind the car that first exited the intersection, going the same direction. In response to the state, the operator begins to re-orient their steering wheel from +45 back to 0 to straighten out the vehicle by the end of the turn to orient the vehicle parallel with the road, and accelerate at a rate that maintains a safe distance from the other vehicle ahead.

In contrast to the trajectories recorded within example 300, the trajectories recorded within example 400 offer more potential driving behaviors to learn from during the training of an autonomous driving model such as conditional imitation learning model 122. Although the three scenarios described are far from sufficient data to realistically be used to train a model independently and the scenarios are not exceedingly complex, it is to be understood that the simplicity of these scenarios is intentional for the purpose of clearly introducing the relevant design landscape and associated challenges of autonomous driving systems. Training an imitation learning system will now be introduced using similar language to that of examples 300 and 400.

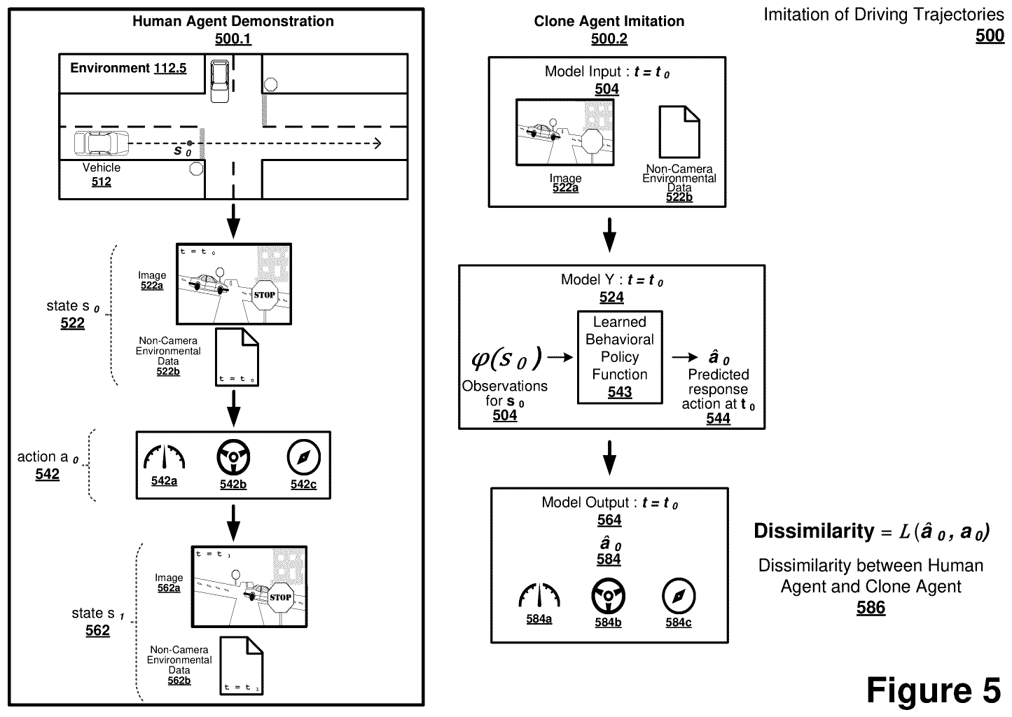

FIG. 5 illustrates an example 500 of a human agent demonstration 500.1 of a driving trajectory and a clone agent imitation 500.2 of the driving demonstration, in accordance with certain implementations of the present disclosure. An environment 112.5 is illustrated consisting of the same intersection scenario from examples 300 and 400. Again, a vehicle 512 approaches a stop sign at the intersection, wherein a car that does not have a stop sign is about to cross the intersection via the cross street. The trajectory to be demonstrated by the human agent within demonstration 500.1, indicated by the grey dashed arrow, now consists of the vehicle driving straight across the intersection rather than turning.

In the given examples, the trajectory states within the environment are observed by both the human operator and the sensing technology coupled to the vehicle. Clearly, the human agent does not experience their surrounding environment as a progression of discrete states to be independently evaluated, nor do they receive information about the environment from the vehicle sensors and cameras. A human driver is more likely to drive intuitively and use their natural cognitive perception of changes over time to make decisions, where their decision-making (either consciously or subconsciously) is informed by their biological senses, connection to a lifetime of experiences interacting with the physical world and using transportation, and contextual knowledge. Although similar, it is also not likely that the information collected by the vehicle precisely or comprehensively matches the information collected by the human operating the vehicle.

However, in the examples thus far, there has not been a clear distinction between the true environment involving human decision-making and the data recorded by the vehicle describing the environment. Within the context of mathematically modeling driving behaviors, the distinction is quite important and should be defined as follows, unless otherwise stated. Any driving demonstration data is an abstraction of the real driving environment controlled by the human operator. A human operator makes decisions while driving via a complex processing process of information that is not feasible to exactly represent within the data. The relationship between the driving environment and the operator's response actions, or the probability distribution of actions performed by the operator given driving states, is the primary behavioral policy of the human operator, π*. Within the real environment, a human driver processes a real state sₜ*to decide an appropriate action, π*(sₜ*), using their driving knowledge and strategy shaped by a range of factors that are not feasible to model. In contrast, the data recorded for a driving demonstration indirectly represents the real state sₜ*as the recorded observations of the state, wherein the limited perspective of the real state sₜ*is denoted simply by sₜ and the observations are denoted by φ(sₜ). Because the primary behavioral policy π*cannot truly be known, the ground truth behavioral policy that maps a state observation φ(sₜ) to the recorded ground truth action aₜ is generally referred to as the reference policy, or simply the ground truth behavioral policy, or the behavioral policy of the expert, agent, operator, human, et cetera.

In many implementations of the technology disclosed, the autonomous driving model is trained to approximate the reference policy from the expert demonstrations via the state-action pairs within the demonstration trajectories. In other implementations using behavioral cloning approaches that aim to imitate the specific ground truth actions of the human expert, the model may learn to closely imitate specific driving tasks with high accuracy. This can be useful in use case scenarios where highly accurate and precise performance in a niche subset of driving tasks is more important than overall generalizability to a broader range of driving environments. However, in use case scenarios where there are high-risk consequences to the autonomous vehicle failing to respond appropriately in response to unexpected or uncommon driving conditions, behavioral cloning of ground truth actions within specific demonstrations may not yield the desired results. Rather, training the model to approximate a learned behavioral policy function that imitates the behavioral policy of the human agent as closely as possible (i.e., convergence of a loss function, a pre-defined minimization threshold for the loss function, or achievement of a pre-defined performance metric goal threshold) enables the autonomous driving model to learn mapped representations of decision-making while driving and relationships between features of driving states and driving actions that can be generalized to an unseen scenario by applying the learned behavioral policy to the state observations of the unseen scenario. In later sections of the description of the present disclosure, additional training and validation methods are described in more detail.

Returning to the discussion of FIG. 5 and example 500 of learning to imitate driving behaviors from a demonstration, human agent demonstration 500.1 is recorded as a series of state-action pairs, wherein a pair (s₀, a₀) is followed by a pair (s₁, a₁). More specifically, a state so has a set of possible actions that can be performed as restricted by the features of the current state, previous states, and the environment, and the execution of a particular action a₀ in response to so influences the transition to a following state s₁, and so on. State s₀ 522 is represented by data collected in the forms of image 522a and any non-camera environmental data 522b. Image 522a, timestamped at t₀, shows a front-facing image from the vehicle's camera system including an upcoming stop sign, the intersection, background structures surrounding the intersection, and another vehicle entering the intersection from the crossroad. The non-camera environmental data 522b, such as location and positioning data, is synced to image 522a using the timestamp at t₀, collectively forming the observations for s₀, φ(s₀)504. Within demonstration 500.1, the human agent executes a particular action a₀ 542, causing actuation of the steering wheel and accelerator/brake systems that affect the speed 542a, orientation of direction 542b, and/or position 542c of vehicle 512. Following particular action a₀542, state s₀ 522 transitions to a state s₁ 562.

The goal of the clone agent in imitation 500.2 is to predict an action do 544 in response to φ(s₀)504 using the current approximation of the learned behavioral policy function 543. To this end, a model input from timepoint to containing image 522a and non-camera environmental data 522b is processed as the observation set φ(s₀)504 by model Y 524. Model Y 524 uses its learned behavioral policy function 543 to map tφ(s₀)504 to a predicted response action â₀544 at t₀. The model output 564 for t₀ is a prediction of the particular set of steering wheel and acceleration actions, â₀ 584 that achieve control conditions 584a, 584b, and 584c reflecting the behavioral policy prediction â₀ 544. To evaluate the divergence between the behavior of the human agent in demonstration 500.1 and the imitated behavior output 564 from the clone agent imitation 500.2, the dissimilarity can be computed in some implementations as a loss function between action a₀ 542 and inferred action â₀ 584. In other implementations where a reference behavioral policy is either known for the human agent, or the driving behavior of the human agent is assumed to reflect the reference behavioral policy, the loss function may also be computed with reference to the behavioral policy function approximation rather than the action itself.

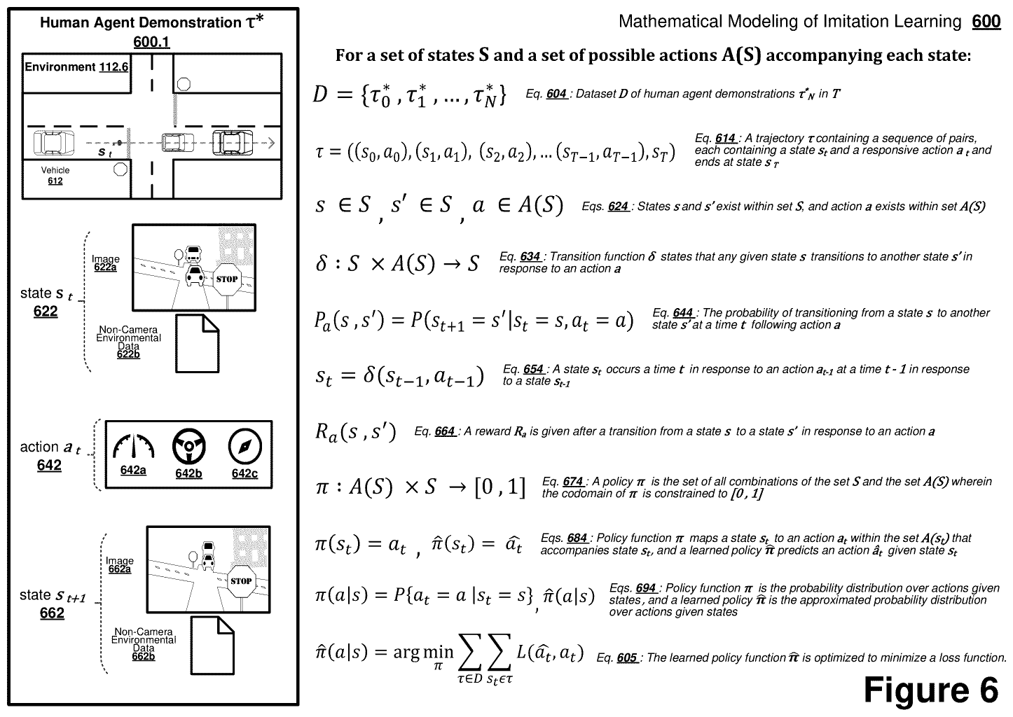

FIG. 6 illustrates an example 600 of a human agent demonstration 600.1 of a true driving trajectory τ*, as well as a mathematical model of an imitation learning framework associated with the driving trajectory 600.1, in accordance with certain implementations of the present disclosure. As described for human agent demonstration 500.1, human agent demonstration 600.1 is recorded as a series of state-action pairs, wherein a pair (sₜ, aₜ) is followed by a pair (sₜ₊₁, aₜ₊₁). State sₜ 622 is represented by data collected in the forms of image 622a and any non-camera environmental data 622b synchronized at a time t. Within demonstration 600.1, the human agent executes a particular action â [symbol] ₜ642, causing actuation of the steering wheel and accelerator/brake systems that affect the speed 642a, orientation of direction 642b, and/or position 642c of vehicle 612. Following particular action a_{τ} 642, state sₜ622 transitions to a state sₜ₊₁ 662. Within demonstration 600.1 of real trajectory τ*, vehicle 612 is stopped at a stop sign at state sₜ 622. There are two cars ahead of vehicle 612, and the human agent demonstrates waiting an appropriate amount of time to move forward at a safe distance from the cars ahead.

Within the real environment 112.6, there is a total set of possible states S and a total set of possible actions A(S) accompanying each state. As shown in equation 604, a dataset D exists containing a total of T true driving trajectories τ_{N}*demonstrated by the human agent within the dataset. Each particular true driving trajectory τ*may be represented as a reference trajectory τ, represented in equation 614. The reference trajectory τ in equation 614 contains a sequence of pairs, and each pair contains a state sₜ and a responsive action aₜ. The final responsive action a_{T-1} is performed at a state s_{T-1}, and subsequently, the trajectory ends at final state S_{T}. Equations 624 further define the sets of possible states and possible actions, respectively, such that a state s and a state s′ exist within the set of all possible states S. Action a is an action existing within the set of all possible actions A(S). In a trajectory, there is a transition function δ (equation 634) that states any given state s will transition to another state s′ in response to an action a.

If we continue to apply equation 634, it follows that a probability function exists (equation 644) Pa(s, s′) equal to the probability of transitioning from a state s to another state s′ at a time t, following the action a. Further, equation 644 shows that a state sₜ occurs at a time t in response to an action âₜ₋₁ at a time t−1 in response to a state sₜ₋₁ using the transition function δ.

In many implementations of the disclosed imitation learning systems and methods, learning is reinforced using a reward function, as shown in equation 644. A particular reward function gives a reward Rₐ after a transition from a state s to a state s′ in response to an action a. The model is trained in a way that rewards desirable behavior, but does not reward undesirable behavior. In one implementation of the technology disclosed, rewards are independently computed and assigned for each transition from a state s to a state s′ in response to an action a. This application of the reward function emphasizes the accuracy of individual actions, like a responsive control of the steering wheel or accelerator on a fine-grained level. In another implementation of the technology disclosed, rewards are independently computed for each transition from a state s to a state s′ in response to an action a, for all state transitions within a trajectory τ, and aggregated (e.g., the summation or average of all computed rewards within the trajectory) so that the complete trajectory τ is assigned an overall reward. This application of the reward function emphasizes larger-scale tasks in a slightly more coarse-grained way, like merging onto a highway from an on-ramp. In yet another implementation of the technology disclosed, rewards are computed in a binary fashion (e.g., R_{τ} is equal to 1 if the end destination is reached and 0 if the end destination is not reached) for each completed trajectory τ, in view of the final result of the trajectory rather than the execution of individual actions or smaller task segments within the trajectory. This application of the reward function emphasizes large-scale ability to drive without crashing, getting stuck or getting lost rather than more specific measures of driving quality.

Equation 674 shows a policy π that is equal to the set of all combinations of set S and set A(S), wherein the codomain of π is constrained between 0 and 1. Equations 684 further represent policy π as the mapping of a state sₜ to an action aₜ within the set of actions A(sₜ) that accompanies state sₜ. Correspondingly, \hat{π} is a learned policy function that approximates a predicted action âₜ given state sₜ. Equations 694 represent each respective policy function π and \hat{π} as probability distributions over actions given states, or more specifically, the probability of action a having the form âₜ given state s having the form sₜ. Using the equations forming the mathematical model within FIG. 6 thus far, we can now represent an optimization function to learn a policy function \hat{π} (equation 605) wherein the learned policy function \hat{π}(a|s) is optimized to minimize the loss function for (âₜ, a [symbol] ₜ (or, in other implementations where the reference behavioral policy is known, the loss function may also be minimized for (\hat{π}, π).

Given the influential and lasting effect previous state data (and thus, action data) has on the future state of a trajectory, there is considerable benefit to modeling the local and global dependencies between trajectory states when predicting driving behaviors. Hence, autonomous driving models are at a disadvantage if they are not able to store any previous information in a memory cache or retrieve that information for contextually-aware decision making. Deep learning architectures configured to achieve memory-informed prediction, such as recursive neural networks or multi-headed attention mechanisms for transformer models, are frequently computationally expensive and, particular given the complexity of autonomous driving problems, slower than desired. In some implementations of the technology disclosed, the complexity of the specific learning problem and/or the computational processing power available warrants the use of these models. However, in most cases, the associated time, monetary, and computing costs of these models can be quite prohibitive and may affect the capacity of the model to achieve safety standards, such as the SOTIF guidelines set forth in ISO standard 21448 as previously described.

The discussion now turns to the introduction of a memory-augmented transformer that leverages input augmentation with memory cached data to enable the use of local and global dependency patterns within driving trajectories with improved efficiency as compared to traditional recursive neural network or transformer models.

### Memory-Augmented Transformer

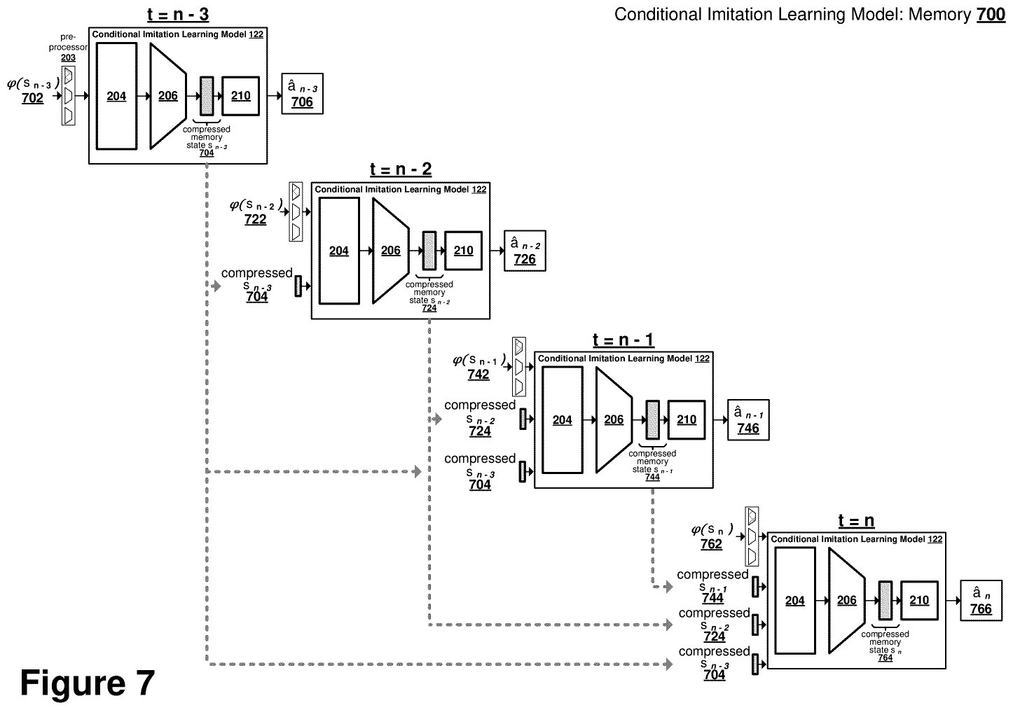

FIG. 7 is an architectural-level schematic 700 of an end-to-end conditional learning model 122 for autonomous driving comprising a memory-augmented transformer, in accordance with certain implementations of the present disclosure. Schematic 700 is equivalent to schematic 200, wherein the processing of four separate time steps is illustrated in a so-called unrolled state. In contrast to a multi-head transformer model that is configured to repetitively process large quantities of input data corresponding to a plurality of sequential states within a trajectory, the memory-augmented transformer illustrated within schematic 700 utilizes a first-in, first-out frame buffer that stores a cached memory state of previously processed states in the trajectory. Each frame, or memory state, within the frame buffer contains the compressed latent space representation of a respective earlier state generated by the second stage processor within the processor stack of schematic 200. Given that the processing of a particular state sₜ by compression layer 206 to receive a corresponding compressed representation of state sₜ for memory storage includes the processing of the n frames within the frame buffer for the earlier states {sₜ₋₁, . . . , sₜ₋ₙ}, assuming a constant frame buffer size, the predicted action ae in response to sₜ is generated in response to compressed data representing the earlier states {sₜ₋₁, . . . , sₜ₋₂ₙ}.

Schematic 700 begins with the processing of data at a timepoint t=n−3 and ends with the processing of a timepoint t=n. A set of observations for a state sₙ₋₃, φ(sₙ₋₃) 702, is assumed to be the earliest state to the processed in the trajectory, therefore no frames are current stored within the frame buffer for timepoint t=n−3. Pre-processor 203 embeds data from φ(sₙ₋₃) 702 in a first stage processor within the overall processing stack, followed by the generation of a compressed memory state representation 704 of state sₙ₋₃ generated in the second stage processor by transformer 204 and compressor 206. The compressed memory state representation 704 of state sₙ₋₃ is processed by the classification head 210 to generate a predicted action âₙ₋₃706.

At timepoint t=n−2, the pre-processor 203 embeds data from φ(sₙ₋₂) 722 in a first stage processor within the overall processing stack. In addition to the embedded data from state sₙ₋₂, the frame buffer now stores a frame for the compressed memory state 704 of state sₙ₋₃. These combined inputs are processed for the generation of a compressed memory state representation 724 of state sₙ₋₂ generated in the second stage processor by transformer 204 and compressor 206. The compressed memory state representation 724 of state sₙ₋₂ is processed by the classification head 210 to generate a predicted action âₙ₋₂726.

At timepoint t=n−1, the pre-processor 203 embeds data from φ(sₙ₋₁) 742 in a first stage processor within the overall processing stack. In addition to the embedded data from state sₙ₋₁, the frame buffer now stores a respective frame for both the compressed memory state 704 of state sₙ₋₃ and the compressed memory state representation 724 of state sₙ₋₂. These combined inputs are processed for the generation of a compressed memory state representation 744 of state sₙ₋₁ generated in the second stage processor by transformer 204 and compressor 206. The compressed memory state representation 744 of state sₙ₋₁ is processed by the classification head 210 to generate a predicted action âₙ₋₁746.

At the last shown timepoint t=n, the pre-processor 203 embeds data from φ(sₙ) 762 in a first stage processor within the overall processing stack. In addition to the embedded data from state sₙ, the frame buffer now stores a respective frame for the compressed memory state 704 of state sₙ₋₃, the compressed memory state representation 724 of state sₙ₋₂, and the compressed memory state representation 744 of state sₙ₋₁. These combined inputs are processed for the generation of a compressed memory state representation 764 of state sₙ generated in the second stage processor by transformer 204 and compressor 206. The compressed memory state representation 764 of state sₙ is processed by the classification head 210 to generate a predicted action âₙ₋₁766.

If the illustration were to show future timesteps of the memory-augmented transformer model, the frame buffer would eventually reach capacity and eventually begin losing the oldest frame, one at a time per timestep, to make room for the storage of the most recent frame. For a training process of the memory-augmented transformer shown in schematic 700, at each predicted action aₜ each time step, a reward function and/or loss function may be computed relative to the predicted action, the trajectory containing the state to which the action responds to, and/or the learned behavioral policy estimated by the conditional imitation learning model 122. Various implementations of the training and validation methods disclosed herein are now discussed in further detail.

### Training and Validation

FIG. 8 is an architectural-level diagram 800 of a training system for training an end-to-end conditional learning model 122 for autonomous driving, in accordance with certain implementations of the present disclosure. The training engine 176 comprises a training stack that uses demonstration data from database 108 to learn from the expert demonstrations. In one implementation of the technology disclosed, the model is trained to clone the behavior of the expert from the demonstrations. In another implementation of the technology disclosed, the model is trained to approximate the behavioral policy of the expert from the demonstrations. In yet another implementation of the technology disclosed, the model is trained to approximate a feature relationship informing the decision of an action in response to the environmental state data. In many implementations of the technology disclosed, a combination of the above learning goals are used in the training of conditional imitation learning model 122. A number of different reward functions and/or loss functions may be used in the training of conditional imitation learning model 122. A user skilled in the art will be familiar with the number of available reward and loss functions applicable for training the disclosed systems.

Additionally, training processes may be further augmented by parameterization of the behavioral policy, online or offline expert labelling of data, the use of fine-tuned datasets for further training of the model, and other optimization methods to be expanded upon further. Within the disclosed training methods and systems, the training engine 176 is often configured in most implementations to utilize demonstration data from the demonstration database 108 for curation of training datasets. From the curated training datasets, which may be sampled at random or to emphasize particular learning goals, observations for a particular state such as φ(sₜ) 802, as well as observations corresponding to the earlier and later states in relation to state sₜ within a particular demonstrated driving trajectory are processed by the processing stack as previously described to predict a response action aₜ 812 that can be evaluated for divergence from a ground truth action aₜ 824 using a particular dissimilarity metric. The dissimilarity metric is a form of loss between the ground truth action aₜ 824 and the predicted response action at 812, wherein backpropagation 804 is used to iteratively update the weights of conditional learning model 122 to minimize the loss function, or dissimilarity metric, 814.

In one implementation of the technology disclosed, the training dataset may be curated from one million or more hours of operator supervised data, or from a smaller corpus such as 100,000 or 50,000 hours or more of operator supervised data. In certain implementations, the method of building a training dataset leverages collecting demonstration data from driving tasks from the fleet 102 of vehicles 102a through 102n operated by human expert/operators 106a through 106n. As aforementioned above, a significant barrier to the development and evaluation of autonomous driving systems is the scalability of the autonomous driving systems and methods. By leveraging a fleet 102 containing passenger vehicles such as vans or trucks, for example, those used for delivery or supply chain transportation tasks that drive extended routes in highly-variable environments, it is possible to efficiently collect a large volume of driving data that benefits from variation in differing true behavioral policies of operators 106, driving environments, driving trajectories, and feature sets of the recorded states. For differing learning goals, a trajectory may focus on a specific driving action or a very short sequence of state-action pairs (e.g., lane changes), focused driving tasks that are longer than simple driving actions (e.g., parallel parking), or destination-guided routes (e.g., leaving a particular start location and arriving at a particular end location, wherein the route may be a set route to be followed or a dynamic route that updates the directional conditions in response to driving behavior). For the purposes of training, a future intended route trajectory may range from very short scales to longer scales in terms of time or distance traveled (e.g., on the scale of seconds versus minutes or on the scale of meters versus kilometers). The million (or fewer) hours of driving demonstrations include encounters with a distribution of different driving tasks while following the intended routes. Examples of demonstrated driving tasks can include lane keeping, turning, avoiding obstacles, parking, navigating, maneuvering in the presence of other moving vehicles, parked vehicles, or pedestrians, driving in differing environments ranging from suburban neighborhoods to freeway stretches, differing weather conditions and road conditions, and so on.

Transporters executing delivery tasks do not require nearly as much training data. Training on one hundred hours of demonstrated delivery tasks or even 15-20 hours of delivery tasks have been demonstrated to produce good delivery robot navigation. The reduced training data reflects sidewalk travel and crossing intersections at low speeds by small, low mass transporters.

Within many implementations of the present disclosure, training methods are performed within the context of driving trajectories defined as entropic situations. Entropic situations, wherein the term “entropic” references the Shannon entropy associated with predicting the appropriate driving behavior given a situation, include situations in which predicted actions deviate from recorded expert actions and/or actions labelled as appropriate. The relationship between certainty, entropy, and the evaluation of difficulty for a driving task is explained in further detail within the description of FIG. 9. Entropic situations often include corner cases and/or edge cases, and certain implementations of the disclosed methods and systems offer strategies for improving the performance of autonomous driving systems in response to corner cases and edge cases.

In one implementation of the technology disclosed, first entropic situations organically arise from driving tasks during demonstrations, which are captured within the observation data. In another implementation, the training methods further include directing the human operator during part of supervised driving to create and resolve second entropic situations. For example, entropic demonstration data may arise from imposing a particular driving task during a particular entropic situation on the particular human operator. In a related implementation, the second entropic situations are labelled to indicate start and finish times of an entropic situation. The vehicles capture observation and action data as the particular human operator extricates the vehicle from the particular entropic situation, which can be demonstrated to the autonomous driving model during training processes for learning.

FIG. 9 is a block diagram of a training system 900 for an autonomous driving neural network, as well as numerous examples of the computation of Shannon entropy 922 and a cross entropy loss function 926, in accordance with certain implementations of the present disclosure.

In one implementation of the training stack disclosed, a driving model 904 is trained using demonstrated driving data, wherein the training can be understood at a high level to involve the processing of an input 902 (e.g., a particular state sₙ), leveraging a Softmax activation function 906 to convert model outputs into class predictions as probabilities, resulting in an output 906 comprising actuation control actions. For clarity and simplicity of the mathematical examples, the only output shown in example implementation 900 is a prediction for the appropriate acceleration/brake response. The ground truth output will indicate a value of 1 for the correct response (decreasing speed, maintaining speed, or increasing speed) and 0 for the remaining two incorrect responses. Deviation between the ground truth action and the predicted action is computed as a loss 908, which is leveraged for backpropagation 910 and iterative updating of the weights within driving model 904.

Before the cross entropy loss function 926 is discussed, the concept of Shannon entropy 922, or entropy in a computational context, will now be introduced. Entropy can be analogously understood as a measure of certainty. The more certain a probability distribution for a system is, the lower entropy that system possesses. Conversely, systems with highly uncertain probability distributions are also highly entropic. Equation 922 defines the computation of entropy for discrete variables as the negative summation of the probability of each particular class scaled by the logarithm of the probability for the particular class. Several examples of the computation for entropy 922 are provided within FIG. 9 in an intuitive context, shapes within a box, and within the context of a statistical model prediction.

Entropy Example A 942 describes a box containing a variety of shapes that are either pentagons, triangles, or circles. For the blind removal of a shape from the box, the probability of the shape having a given geometry is equal to the total number of shapes with the given geometry within the box divided by the total number of all shapes within the box. There is not a strong majority shape within the box, as illustrated. There is a 20% chance the shape will be a pentagon, a 30% chance the shape will be a triangle, and a 50% chance the shape will be a circle. Using the provided probabilities, the entropy calculation is shown for a total value of 1.485. If one were asked to guess the shape they will pull out of the box, they would not be able to do so with a very high degree of certainty. In other words, the scenario within Example A 942 can be described as an entropic situation.

In contrast, Entropy Example C 962 shows a similar box with the same types of shapes included as shown within Example A 942. However, in Example C 962, there is a 90% chance the shape will be a pentagon, a 10% chance the shape will be a triangle, and no chance the shape will be a circle. Repeating the same experiment for Example C 962, the individual removing a shape from the box can be quite certain that the shape will likely be a pentagon. The entropy calculation using the provided probabilities is shown for a total value of 0.469. Intuitively, it is logical to learn that the quantitative entropy of Example C 962 is lower than that of Example A 942, given that our ability to confidently guess the outcome for Example C 962 is much better than that of Example A 942.

Entropy Example B 944 and Entropy Example D 964, respectively, have the same probability values as Entropy Example A 942 and Entropy Example C 962. Within Example B 944 and Example D 964, the probabilities correspond to the predicted output values 906 in response to an input 902 for driving model 904. Entropy Example D 964 corresponds to a low entropy situation, like an input of traffic light color, whereas Entropy Example B 944 corresponds to a high entropy situation (referred to herein as an entropic situation), like driving over icy roads.

Cross entropy loss functions, as represented by equation 926, employ the concept of entropy to quantify loss as a measure of uncertainty in output prediction values. Specifically, cross entropy loss effectively measures the confidence that the model will output the ground truth value. For Cross Entropy Loss Example E 946, the model output predicts a value of 0.9 for the ground truth class, which is a fairly confident prediction and thus, has low entropy. For Cross Entropy Loss Example F 966, the model output predicts a value of 0.7 for the ground truth class, holds more entropy than Example E 946. Cross entropy loss functions and related loss functions drive machine learning models to optimize model parameters to improve the confidence that the model will output ground truth values in response to input data.

Cross entropy loss functions are not as effective in situations where the training dataset is imbalanced. In situations where there is a majority class, the model may be able to minimize the cross entropy function simply by increasing confidence for the majority class without ever learning the minority class. Similarly, in situations where there exists a small number of substantially harder data observations to train on, these difficult scenarios are unlikely to be learned by the model even following optimization. To address these concerns, a number of tuning parameters exist to modify cross entropy loss. For the training of autonomous driving models, these tuning parameters are advantageous to encourage model learning of corner cases and edge cases, particularly if there are not many examples of these cases within the dataset. Even with the use of fleets for large generation of demonstrations, corner cases and edge cases will still compose a lesser proportion of the training data by nature. In some implementations of the technology disclosed, a focal loss function is used to train the disclosed processing stack. Focal loss functions modify cross entropy loss with a focusing parameter that focuses the model on learning difficult examples to effectively minimize loss.

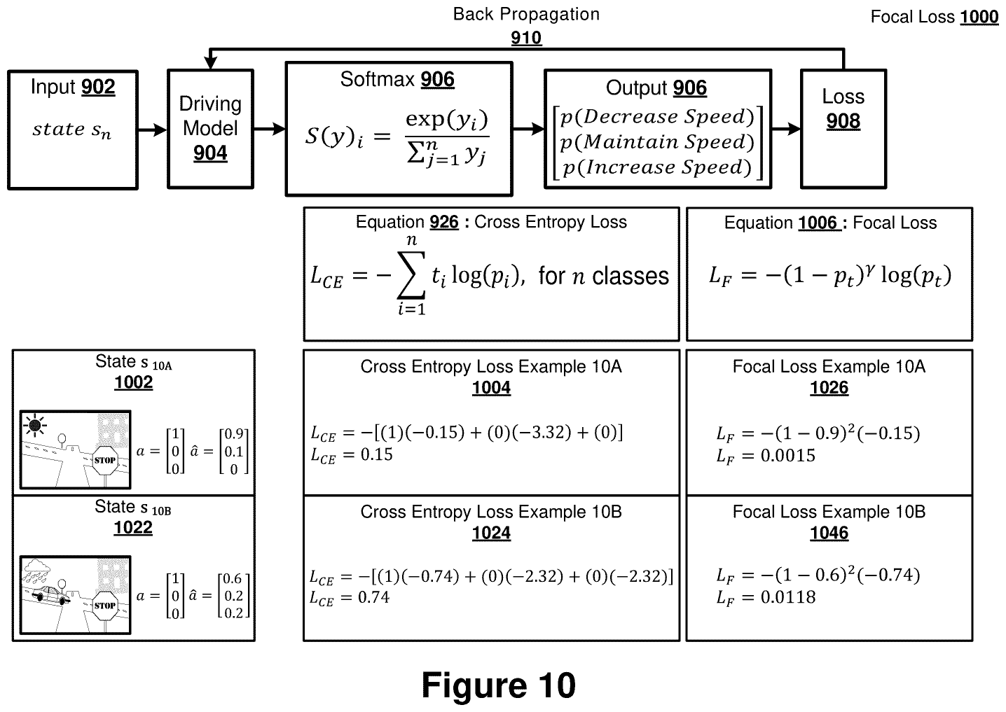

FIG. 10 is a block diagram of a training system 1000 for an autonomous driving neural network 904, as well as a comparison of the computation of a cross entropy loss function 926 and a focal loss function 1006 for the training system, in accordance with certain implementations of the present disclosure. Briefly, our example training stack mirrors that of FIG. 9, including the processing of an input 902 (e.g., a particular state sₙ), leveraging a Softmax activation function 906 to convert model outputs into class predictions as probabilities, resulting in an output 906 comprising actuation control actions. Minimization of loss 908 drives the backpropagation 910 and iterative updating of driving model 904.

A first driving state S_{10A} 1002 is shown, wherein the driving demonstration, including the driving task of stopping for a stop sign, is performed under clear weather conditions. The ground truth response action is to decrease speed. In a second driving state s_{10B} 1022, the driving demonstration is repeated on a day where there is heavy rain affecting traction and visibility. The predicted action for S_{10A} 1002 is represented by a 90% probability for decreasing speed. However, the predicted action for s_{10B} 1022 is represented by a 60% probability for decreasing speed. First, examples are given for calculating the respective loss for each state-action prediction using cross entropy loss. In Cross Entropy Loss Example 10A 1004, the cross entropy loss for S_{10A} 1002 is 0.15, whereas in Cross Entropy Loss Example 10B 1024, the cross entropy loss for s_{10B} 1022 is 0.74, approximately 4.9× higher than that of S_{10A} 1002.

Next, the loss is compared between S_{10A} 1002 and s_{10B} 1022 using a focal loss function 1006. The focusing parameter y applied in equation 1006 applies an added penalty that scales the resulting loss contribution from a particular training example, wherein the penalty scaling exponentially degrades to 0 as confidence in the prediction increases. In Focal Loss Example 10A 1026, the focal loss for S_{10A} 1002 is 0.0015, whereas in Focal Loss Example 10B 1046, the focal loss for s_{10B} 1022 is 0.0118, approximately 7.9× higher than that of S_{10A} 1002. These examples are provided to demonstrate the way in which difficult examples will have a higher contribution to overall training loss within a training dataset; hence, the effect of learning easy examples will have significantly less benefit to minimization of the training loss than the effect of learning difficult examples. This focusing parameter is applied to the training loss within many implementations of the disclosed system and methods to improve the efficiency of learning entropic situations, such as corner cases like driving in heavy rain, within training demonstration data.

The discussion now turns to a description of the validation methods implemented within the present disclosure. In addition to the disclosed training methods discussed thus far, the disclosed validation methods and systems offer further training optimization through the use of approaches such as dataset aggregation, corrective learning, fine-tuning, and transfer learning.

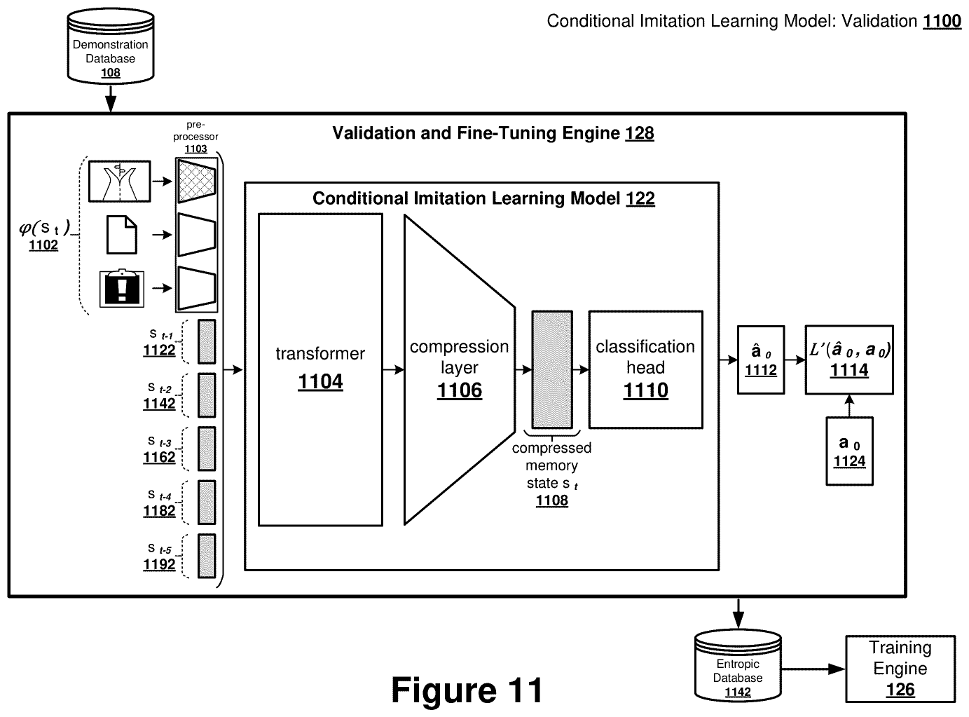

FIG. 11 is an architectural-level diagram of a validation system 1100 for an end-to-end conditional learning model 122 for autonomous driving, in accordance with certain implementations of the present disclosure. The validation and fine-tuning engine 128c uses demonstration data from database 108 to validate the performance of the trained imitation learning model 122, as well as identify areas in need of further improvement. In one implementation of the technology disclosed, the model is validated on cloning the behavior of the expert from the demonstrations. In another implementation of the technology disclosed, the model is validated on approximating the behavioral policy of the expert from the demonstrations. In yet another implementation of the technology disclosed, the model is validated on approximating a feature relationship informing the decision of an action in response to the environmental state data. In many implementations of the technology disclosed, a combination of the above learning goals are used in the evaluation of conditional imitation learning model 122. In certain disclosed implementations, the validation procedure evaluates model performance for a particular class of driving tasks, whereas in other implementations, the validation procedure evaluates model performance for a varied and generalized class of driving tasks. In one implementation, the performance validation is based on the quality of execution for specific driving tasks. In another implementation, the performance validation is based only on whether or not the autonomous driving vehicle completes a route or not, or drives for a period of time without crashing. In some implementations, validation is performed virtually in a simulation environment 118 in advance of, or in the place of, validation in the real world environment 112. In other implementations, validation is performed in a controlled real world location 112 wherein the trained autonomous vehicle is geofenced and controlled by a number of safety measures, including the ability of a human operator to stop the vehicle and/or take control of the vehicle at any point in time.

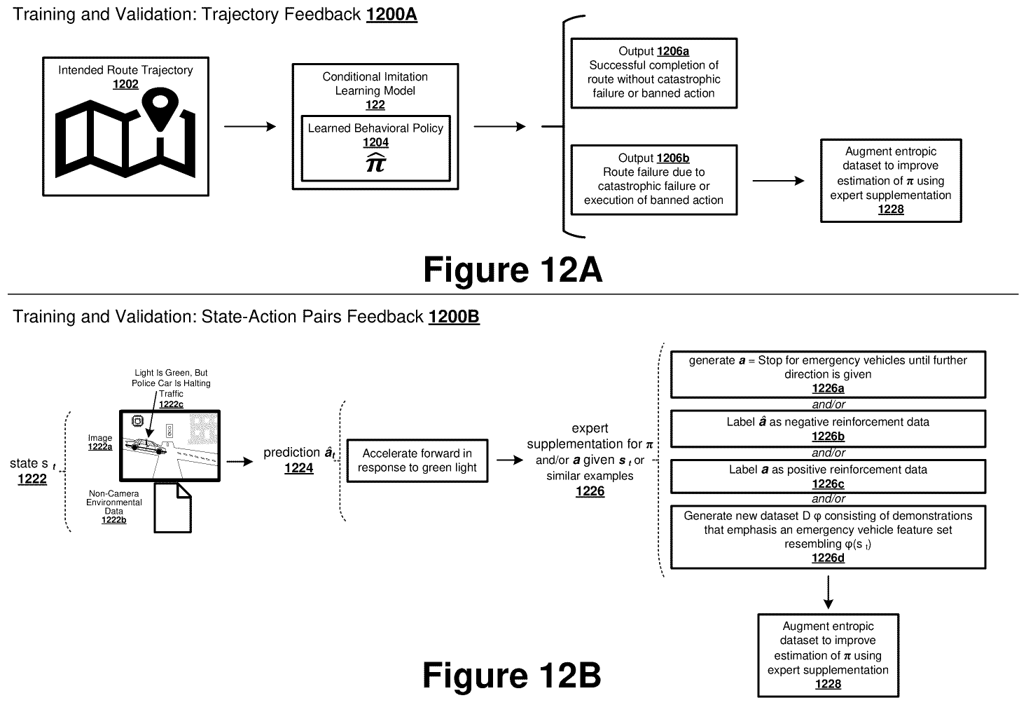

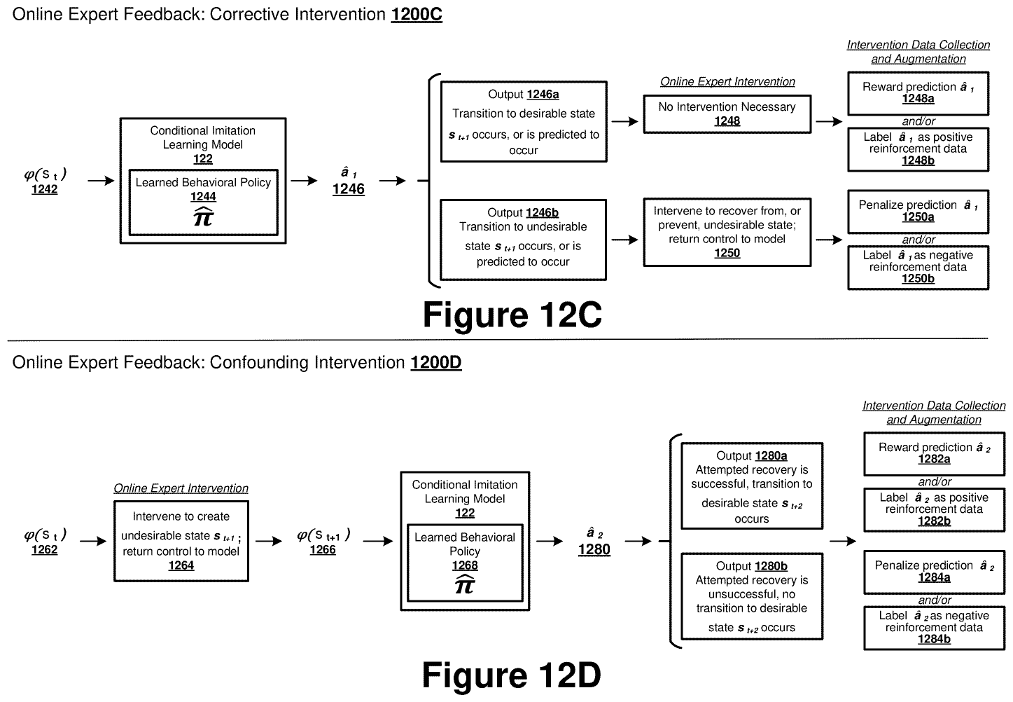

FIG. 12A is a block diagram 1200A of a training and validation system using trajectory feedback, in accordance with certain implementations of the present disclosure. Provided an intended route trajectory 1202, for instance, wherein the directive conditions provided to the model require a specific route to be followed given instructions, the conditional imitation learning model 122 trained to approximate a learned behavioral policy 1204 is validated for either an output 1206a, the successful completion of the route without catastrophic failure, or an output 1206b, wherein route failure occurs. In some implementations, a route may be classified as a failure even if the route has been completed as a result of a banned action occurring such as illegal maneuvering, excessive speeding, or a non-catastrophic collision. In some implementations of the technology disclosed, data corresponding to a route trajectory 1202 (or, specific driving tasks and/or actions within route trajectory 1202) that the trained model 122 is unable to perform will be flagged as third entropic situations to be used in additional training situations in an operation 1228.

In some implementations, the third entropic situations are leveraged to fine-tune a previously trained version of the trained model 122. In other implementations, the third entropic situations are leveraged to inform recording of supplemental expert demonstrations. In yet other implementations, transfer learning may be employed to augment the performance of a first trained version of a generalized model that is weak to a particular class of driving tasks with the behavioral policy of a second trained version of a highly-focused model that is trained for the particular class.

FIG. 12B is a block diagram of a training and validation system 1200B using state-action pair feedback, in accordance with certain implementations of the present disclosure. A trained conditional imitation learning model 122 is validated on its performance to predict a particular action in response to a given state. For example, the example validation state in system 1200B shows a state sₜ 1222 wherein the vehicle is approaching a green light, but a nearby police vehicle 1222c identified within image 1222a is signaling for traffic to halt. However, the model predicts an action âₜ 1224 in response to state sₜ 1222 executing forward acceleration to the green light, ignoring the police instruction. The divergence between the correct action and action âₜ 1224 may be addressed using expert supplementation for the behavioral policy π and/or the specific state-action pair sₜ 1222/âₜ 1224. Expert supplementation may also involve the training supplementation with similar examples that closely resemble state sₜ 1222.

In one implementation, the expert may provide direct feedback to the failed state-action pair sₜ 1222/âₜ 1224 with the correct action a 1226a in response to emergency vehicles and authority instructions. In another implementation, action âₜ 1224 may be labeled as a negative reinforcement driving task example 1226b for future training iterations on what not to do. In yet another implementation, the correct action a 1226a may be labeled as a positive reinforcement driving task example 1226c for future training iterations. In yet another implementation, the flagged entropic situation 1222 will be used to generate new driving demonstrations that emphasize features and feature sets that resemble φ(sₜ) 1226d for use in an entropic situation dataset D_{φ} or augmentation of a more generalized dataset. In many implementations, a combination of multiple of the operations 1226a, 1226b, 1226c, and/or 1226d are used. The state sₜ 1222 will be flagged as a third entropic situation that can be used to augment training processes to improve the learned behavioral policy estimation using the expert's supplementation in an operation 1228.

FIG. 12C is a block diagram of an intervention learning system 1200C using corrective intervention from an online expert, in accordance with certain implementations of the present disclosure. The use of online experts allows for feedback from human operators in the middle of training and evaluation processes, rather than analyzing results after-the-fact. For example, the example shown for system 1200C involves a trained conditional imitation learning model 122 that has learned an estimated behavioral policy 1244 being evaluated on a driving task represented by an input φ(sₜ) 1242, to which a predicted action â₁ 1246 is executed in response to the input observations of the environmental driving state. The predicted action â₁ 1246 may either result in an output 1246a, where a transition to a desirable state sₜ₊₁ occurs (or, is predicted to occur) or an output 1246b, where a transition to an undesirable state sₜ₊₁ occurs (or, is predicted to occur). Within system 1200C, the role of the online expert is to provide corrective intervention in the case of output 1246b.

If output 1246a (desirable outcome) occurs, the expert will not intervene in operation 1248. The lack of intervention may result in a reward R_{â1} 1248a being given, and/or the labeling of action â₁ 1246 as positive reinforcement data 1248b for future training purposes. However, if output 1246b (undesirable outcome) occurs, the expert will intervene in operation 1250. The corrective intervention may involve demonstrating to the conditional imitation learning model 122 how to recover from the undesirable state, or preventing the undesirable state from occurring at all, before returning control to conditional imitation learning model 122. In one implementation of the technology disclosed, the conditional imitation learning model 122 restarts the driving task from the first state using the newly learned information. In another implementation, the conditional imitation learning model 122 is reset to a point directly before the bad decision â₁ 1246 was made. In yet another implementation, the model resumes the driving task from the point at which the operator extricated the vehicle and put the vehicle back on course. The intervention may result in a penalty 1250a being given, and/or the labeling of action â₁ 1246 as negative reinforcement data 1250b for future training purposes.

FIG. 12D is a block diagram of an intervention learning system 1200D using confounding intervention from an online expert, in accordance with certain implementations of the present disclosure. In contrast to system 1200C, the online expert within system 1200D intervenes to cause entropic situations, rather than demonstrate appropriate responses to entropic situations. In response to an input φ(sₜ) 1262, the online expert takes control of the vehicle in an operation 1264 to create an undesirable state (e.g., entropic situation) s^{t+1} before returning the control to the trained model to evaluate the model's ability to extricate itself from the entropic situation. The trained conditional imitation learning model 122, using its learned approximation of the behavioral policy 1268, predicts an action â₂ 1280 in response to the input φ(sₜ₊₁) 1266.

If output 1280a occurs, the attempted recovery by the conditional imitation learning model 122 is considered successful and transition to a desirable state sₜ₊₂ occurs. The successful recovery may result in a reward Rₐ₂ 1282a being given, and/or the labeling of action â₂ 1280 as positive reinforcement data 1282b for future training purposes. However, if output 1280b occurs, the attempted recovery by the conditional imitation learning model 122 is considered unsuccessful and transition to an undesirable state sₜ₊₂ occurs. The failed attempt may result in a penalty 1284a being given, and/or the labeling of action â₂ 1280 as negative reinforcement data 1250b for future training purposes.

In implementations where entropic data is collected for future training and optimization procedures, the entropic data may be used as its own dataset, or merged into a broader dataset with additional driving tasks using a dataset aggregation method. Dataset aggregation methods can be used to improve the learned behavioral policy and improve the generalizability of a model, as compared to fine-tuning a model for a specific driving task. The process for dataset aggregation with entropic situations is summarized below in Algorithm (1).

Algorithm (1): Dataset Aggregation

Expert Policy: π
Learned Policy Obtained in Training: \hat{π}

D ← 0

```
Initialize \hat{π}
for i = 1 to N, do:
  πᵢ = βᵢ π + (1 − βᵢ) \hat{π}
  Validate policy πᵢ to sample trajectory τᵥ = {s₀, s₁, ..., S_{T - 1}, s_{T}}
  Obtain operator feedback to generate dataset:
    Dᵢ = {(s₀, π(s₀ )), (s_1, π(s_1 )), ... (s_(T − 1), π(S_{T - 1} )), (sₜ,
    π(S_{T} ))}
  Aggregate datasets, D ← D ∪ Dᵢ
  Retrain policy \hat{π} using aggregated dataset D
return \hat{π}
```

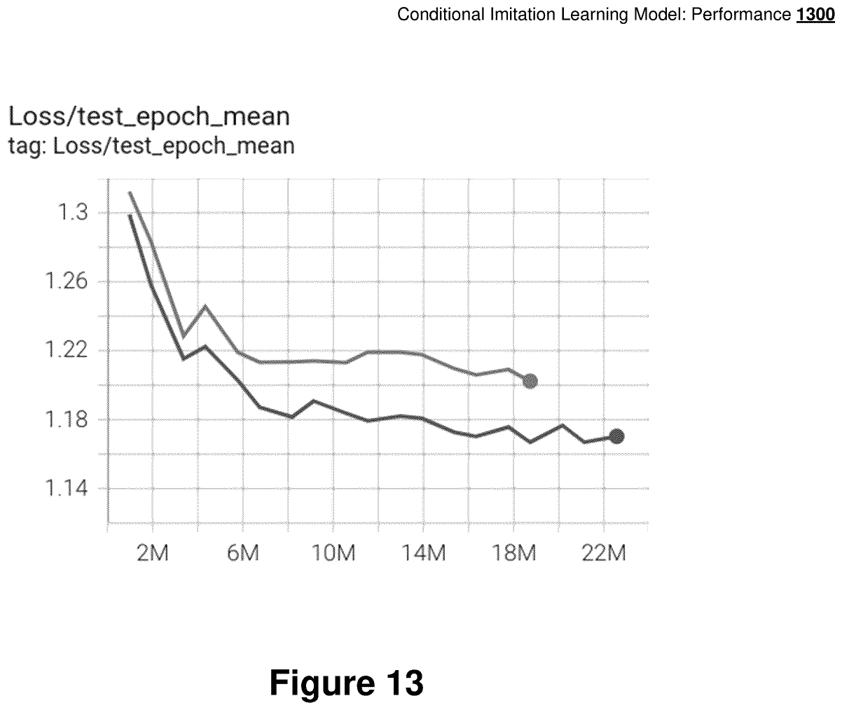

FIG. 13 is a graph 1300 representing the optimization of a cross entropy loss function during training of an implementation of conditional imitation learning model 122 with and without a focusing parameter, in accordance with certain implementations of the present disclosure. The top line corresponds to the minimization of a cross entropy loss function for the training of the conditional imitation learning model 122 without the use of a focusing parameter, and the bottom line corresponds to the minimization of a cross entropy loss function for the training of the conditional imitation learning model 122 with the use of a focusing parameter.

### Autonomous Transporters

Certain implementations of the technology disclosed involve the use of the autonomous driving model described herein for autonomous transporter robots, such as hyper-local deliver robots, rather than passenger vehicles. The implementations corresponding to autonomous transporter robots relate to technology disclosed in a prior application, titled “Multi-Functional Inventory Storage and Delivery System” with application No. 63/443,342 and filed provisionally on Feb. 3, 2023, which is incorporated by reference herein. Briefly, the delivery system and structure corresponding to the autonomous transporters will be summarized below.

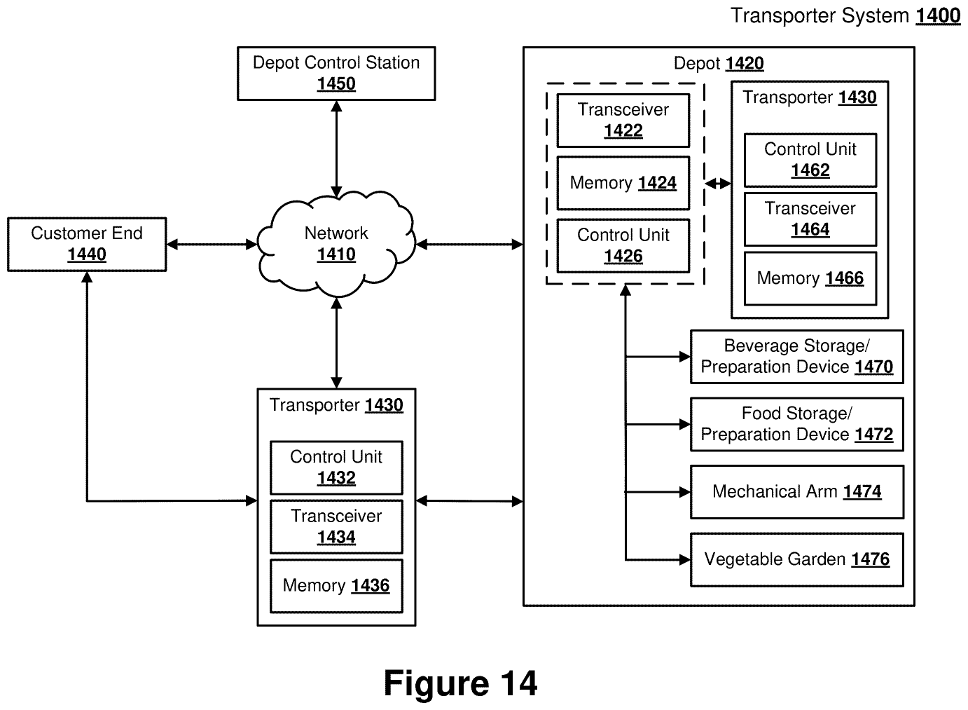

FIG. 14 is a block diagram 1400 of components of a hyper-local provisioning and delivery system including a depot and a plurality of transporters, in accordance with certain implementations of the present disclosure. The hyper-local provisioning and delivery system 1400 includes depot 1420, one or more transporters 1430 in transit for package delivery, customer destination 1440 and depot control station 1450 that are connected to at least one network 1410. The wireless PHY layer of the network can include a cellular network, a low earth orbit satellite network, a wi-fi and/or other network. Each of the transporters 1430 includes a control unit 1432, a signal transceiver 1434/1464 and memory 1436/1466. The control unit 1432 is adapted to determine the torque applied to the flange wheels and control the motorized drives. The control unit 1432 also controls other components of the transporter, including cameras, radars, optical and/or thermo sensors, speakers, navigation system, and/or facial recognition system. The signal transceiver 1434/1464 receives signals from the depot 1420 controlling the transporter to transport to a designated location.

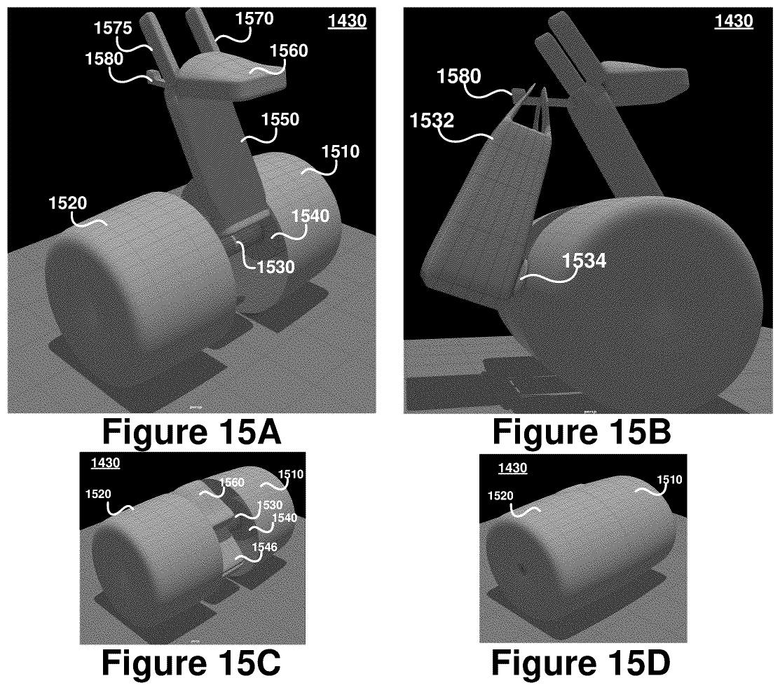

FIG. 15A illustrates an example of a transporter 1430 in a second extended or cruise position, in accordance with certain implementations of the present disclosure. The transporter 1430 includes a collapsible column 1530 and a collapsible neck 1550 attached to the collapsible column 1530. At the cruise position, both the collapsible column 1530 and collapsible neck 1550 are extended above the flange wheels 1510/1520. Motorized drives are connected to the flange wheels and apply torque to the wheels. A control unit in the transporter is adapted to determine the torque applied to the flange wheels and control the motorized drives. A power supply (e.g., battery, solar panels) is coupled to the motorized drives. The collapsible neck 1550 supports a handle 1580 and a head 1560. The handle 1580 can be grasped by the mechanical arm to deploy the transporter 1430 from the depot 1420 and to retract it. The handle 1580 can carry a package of goods for delivery.

FIG. 15B illustrates another example of a transporter 1430 in a second extended position with a package secured on the transporter, in accordance with certain implementations of the present disclosure. The transporter 1430 is at cruise mode with the package 1532 secured on the handle 1580. The transporter 1430 also includes a multifunction mudflap 630 attached to the collapsible column. The mudflap helps support the package for delivery. By positioning between the package and the flange wheels, the mudflap 1546 also prevents the package 1532 from contacting the wheels.

FIG. 15C illustrates an example of a transporter 1430 in a first extended position, in accordance with certain implementations of the present disclosure. In the first extended position, the column 1530 can be partially collapsed and therefore, the distance between the flange wheels 1510 and 1520 is shorter than that in the cruise position. The neck 1550 can be fully or partially collapsed. As illustrated, the neck 1550 is folded and partially covered by the tires of the flange wheels 1510 and 1520. The head 1560 is also folded in proximity to the neck 1550 and partially covered by the tires. In one implementation, the handle on the head 1560 is exposed and reachable by the mechanical arm.

FIG. 15D illustrates an example of a transporter 1430 in a compact position, in accordance with certain implementations of the present disclosure. In the compact position, the column of the transporter 1430 is fully collapsed and the distance between the flange wheels 1510 and 1520 is minimized. The neck and head of the transporter 1430 is positioned inside rims of the flange wheels and covered by the tires. In one implementation, the transporter 1430 in the compact position is stored and charged at the transporter station in the depot. As the size of the transporter 1430 is minimized in the compact position, it allows the transporter station to store a plurality of transporters.

One implementation of the disclosed methods and systems for building a training dataset can be applied to the training of autonomous transporters 1430 for delivery tasks. In contrast to fleet vehicles operated by human operators, data collection for the training of autonomous transporters 1430 (for example, one hundred hours of training) involves human operators each supervising autonomous transporters 1430 on intended routes to perform delivery tasks. While many of the training driving tasks are similar to that of the passenger vehicles, the operation of delivery robots requires unique demonstrations related to the operation of a robot within shared spaces with pedestrians. While collisions are less consequential, they may be more likely in certain scenarios, requiring sufficient collection of demonstrations for avoiding pedestrians and other obstacles.

Some implementations of the disclosed training methods involve the curation of at least fifteen hours of transporter demonstration data for training of the conditional imitation learning model 122 for autonomous transporter delivery tasks. Similarly to the above-described training procedures, training procedures involve learning from a first set of entropic situations that organically arise within driving demonstrations, a second set of entropic situations that are created and resolved in planned entropic demonstrations, and/or additional entropic situations that are identified within training and optimization operations.

### Computer System

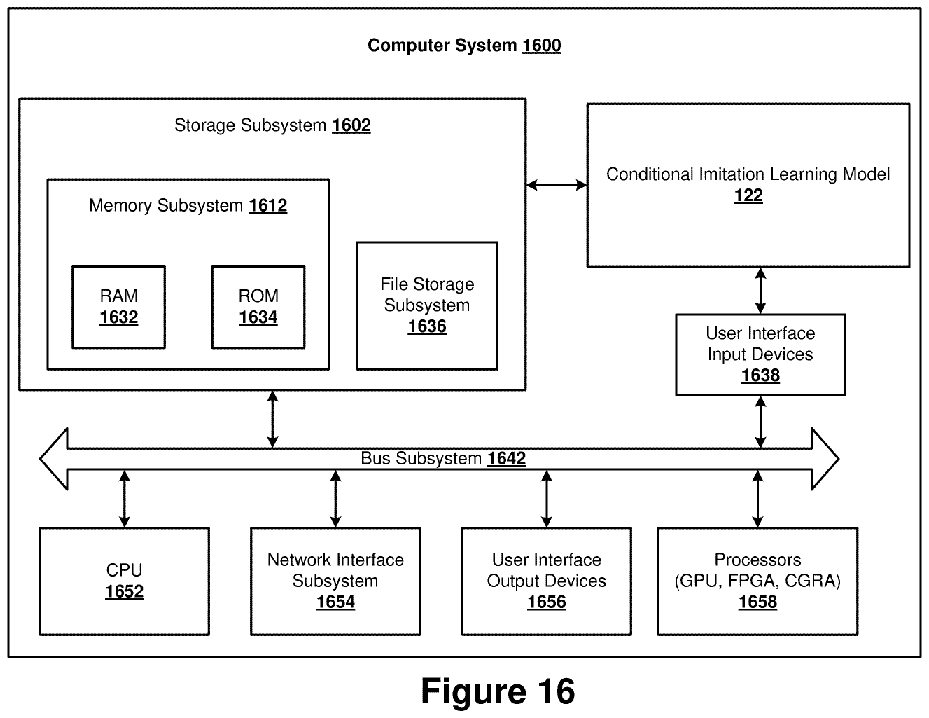

FIG. 16 is a computer system 1600 that can be used to implement the technology disclosed. Computer system 1600 includes at least one central processing unit (CPU) 1652 that communicates with a number of peripheral devices via bus subsystem 1642. These peripheral devices can include a storage subsystem 1602 including, for example, memory devices and a file storage subsystem 1636, user interface input devices 1638, user interface output devices 1656, and a network interface subsystem 1654. The input and output devices allow user interaction with computer system 1600. Network interface subsystem 1654 provides an interface to outside networks, including an interface to corresponding interface devices in other computer systems.

In one implementation, the conditional imitation learning model 122 is communicably linked to the storage subsystem 1602 and the user interface input devices 1638.

In another implementation, the control unit 1426 of the depot and the control unit 1432 of the transporter are also communicably linked to the storage subsystem 1602 and the user interface input devices 1638.

User interface input devices 1638 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1600.

User interface output devices 1656 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1600 to the user or to another machine or computer system.

Storage subsystem 1602 stores programming and data constructs that provide the functionality of some or all of the modules and methods described herein. These software modules are generally executed by processors 1658.

Processors 1658 can be graphics processing units (GPUs), field-programmable gate arrays (FPGAs), application-specific integrated circuits (ASICs), and/or coarse-grained reconfigurable architectures (CGRAs). Processors 1658 can be hosted by a deep learning cloud platform such as Google Cloud Platform™, Xilinx™, and Cirrascale™. Examples of processors 1678 include Google's Tensor Processing Unit (TPU)™, rackmount solutions like GX4 Rackmount Series™, GX16 Rackmount Series™, NVIDIA DGX-1™, Microsoft′ Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1612 used in the storage subsystem 1602 can include a number of memories including a main random access memory (RAM) 1632 for storage of instructions and data during program execution and a read only memory (ROM) 1634 in which fixed instructions are stored. A file storage subsystem 1636 can provide persistent storage for program and data files, and can include a hard disk drive, a floppy disk drive along with associated removable media, a CD-ROM drive, an optical drive, or removable media cartridges. The modules implementing the functionality of some implementations can be stored by file storage subsystem 1636 in the storage subsystem 1602, or in other machines accessible by the processor.

Bus subsystem 1642 provides a mechanism for letting the various components and subsystems of computer system 1600 communicate with each other as intended. Although bus subsystem 1642 is shown schematically as a single bus, alternative implementations of the bus subsystem can use multiple busses.

Computer system 1600 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1600 depicted in FIG. 16 is intended only as a specific example for purposes of illustrating the preferred implementations of the present invention. Many other configurations of computer system 1600 are possible having more or less components than the computer system depicted in FIG. 16.

Each of the processors or modules discussed herein may include an algorithm (e.g., instructions stored on a tangible and/or non-transitory computer readable storage medium) or sub-algorithms to perform particular processes. The conditional imitation learning model 122 is illustrated conceptually as a collection of modules, but may be implemented utilizing any combination of dedicated hardware boards, DSPs, processors, etc. Alternatively, the conditional imitation learning model 122 of system 100 may be implemented utilizing an off-the-shelf PC with a single processor or multiple processors, with the functional operations distributed between the processors. As a further option, the modules described below may be implemented utilizing a hybrid configuration in which some modular functions are performed utilizing dedicated hardware, while the remaining modular functions are performed utilizing an off-the-shelf PC and the like. The modules also may be implemented as software modules within a processing unit.

Various processes and steps of the methods set forth can be carried out using a computer. The computer can include a processor that is part of a detection device, networked with a detection device used to obtain the data that is processed by the computer or separate from the detection device. In some implementations, information (e.g., image data) may be transmitted between components of a system disclosed herein directly or via a computer network. A local area network (LAN) or wide area network (WAN) may be a corporate computing network, including access to the Internet, to which computers and computing devices comprising the system are connected. In one implementation, the LAN conforms to the transmission control protocol/internet protocol (TCP/IP) industry standard. In some instances, the information (e.g., image data) is input to a system disclosed herein via an input device (e.g., disk drive, compact disk player, USB port etc.). In some instances, the information is received by loading the information, e.g., from a storage device such as a disk or flash drive.

A processor that is used to run an algorithm or other process set forth herein may comprise a microprocessor. The microprocessor may be any conventional general purpose single- or multi-chip microprocessor such as a Pentium™ processor made by Intel Corporation. A particularly useful computer can utilize an Intel Ivybridge dual-16 core processor, LSI raid controller, having 168 GB of RAM, and 2 TB solid state disk drive. In addition, the processor may comprise any conventional special purpose processor such as a digital signal processor or a graphics processor. The processor typically has conventional address lines, conventional data lines, and one or more conventional control lines.

### Particular Implementations

The technology disclosed can be practiced as a method, apparatus, or article of manufacture. It is useful with rolling vehicles such as automobiles and trucks. It also is useful with rolling delivery robots, such as the transporter described in a prior application, and further described within the present disclosure. One method involves assembling a training set of data with representative samples of routine driving situations and enhancing the representative samples with entropic driving situations. A related method involves the training of an E2E imitation learning model or conditional imitation learning model with end-to-end conversion of input states into actuation signals for steering and acceleration. Methods further include validation methods in various modes of operation from operation of a shadow ML navigation system to a human copilot watching over a trained ML navigation system, to a human actor occasionally confounding operation of an ML navigation system autonomous vehicle. Disclosed training methods that may be implemented within a shadow ML navigation system or a human copilot can be identified within the description of FIGS. 12A-12B, in particular. In this section, we also describe a training set selector, a production stack and a training stack that extends the production stack.

One implementation of the technology disclosed is a computer-implemented method for building a training data set to train an end-to-end neural network for autonomous driving tasks. This training data set may be curated from a million or more hours of operator supervised driving data, or from a smaller corpus, such as 100,000 or 50,000 hours or more of operator-supervised driving data. A much smaller training data set can be curated for a delivery robot or transporter. A training set can be curated from 1000 hours of operation or even 100 hours of operation. Initial work with transporters found that training to maneuver on sidewalks could be accomplished with as little as 15 hours of selected representative demonstration data.

The method of building a training data set leverages collecting, from a fleet of human operator supervised vehicles, demonstration data from driving tasks. Human operators in the fleet each supervise their vehicle through a driving task. Typically, driving tasks are completed during extended routes. For purposes of training, an intended route for at least the next 3 seconds, five seconds, ten seconds or twenty second may be enough to train the vehicle or delivery robot for the following intended path, including tasks such as making timely turns and not colliding with stationary or moving objects. As it moves, the vehicle captures data for a sequence of driving states including at least video from one camera, location data from a GNSS receiver, a velocity vector of travel, steering wheel orientation, and accelerator/brakes actuation. Optionally, it also may capture radar or LiDAR image data. In certain implementations, training data will further include information about the operator's eye movements using retinal tracking data.

The million (or fewer) hours of operator-supervised driving data includes encounters with a distribution of driving tasks following the intended routes. The driving tasks may include scenarios such as lane keeping, turning, arriving at a destination, parking, navigating in the presence of moving and parked vehicles and pedestrians, obeying traffic signals, and avoiding collisions.

During capture of data from a fleet, first entropic situations organically arise from driving tasks and are captured in the driving data. By entropic situations, we refer to driving trajectories in which machine learning generated actuation signals deviate from recorded human actuation decisions.

The disclosed may further include directing the human operator during part of supervised driving demonstrations to create and/or resolve second entropic situations. This can be done, for example, by imposing on a particular driving task a particular entropic situation for a particular human operator in the fleet to execute. Preferably, the system flags at least the start of operator execution of the second entropic situations. The vehicles capture driving data as the particular human operator extricates the vehicle from the particular entropic situation.

From the million, 100,000, 50,000 or fewer hours, a training set data is curated to produce a training set of driving data to imitate. One aspect of the curating can include the selection of a representative sample of base routine driving situations marked with starts and ends. Another aspect includes identifying first entropic situations that naturally arose during driving demonstrations and selecting a set of first entropic situations. These situations can be labelled with starts and ends. Another aspect includes locating the flagged second entropic situations and selecting a set of second entropic situations with starts and ends. The entropic situations can be screened to exclude or label as negative examples driving tasks, if any, that produced an avoidable collision with a moving or stationary object. The system saves the curated driving data for use in training an E2E learning model to automate the vehicle. Conditional imitation learning is a preferred use of this training data set, but additional disclosed implementations include reinforcement learning, apprenticeship learning, behavioral cloning, expert intervention learning, and reverse imitation learning in training processes that are supervised, semi-supervised, or unsupervised. Inclusion of entropic situations aids to balance the representative sample of base routine driving situations. A balanced data set can be useful in training any model, using captured steering wheel orientation and accelerator and braking actuation as ground truth, features associated with environmental states as ground truth, feature relationships as ground truth, and/or behavioral policies as ground truth.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as assembling traded datasets, training with the data sets, use of train production stacks, training of the production stacks, and validation of trained production stacks.

The compiled training data set from the prior method can be used in a training method. The training includes initializing an end-to-end conditional imitation learning model to automate the vehicle. This end-to-end conditional imitation learning model is configured to imitate a behavioral policy of steering and accelerator/brakes actuation. This behavioral policy can be defined by a probability distribution of actions given states in the curated training data set. The imitated behavioral policy is leveraged to predict driving control action such as steering and acceleration. Predictions are made responsive to the present state of the vehicle including a visual image, location, intended path, and steering and accelerator/brake actuation, combined with a compressed representation from at least five earlier states over at least three seconds, and with at least one intended route condition. the training method further includes training the conditional imitation learning model with the curated training data set to imitate the behavioral policy of the human operators in the fleet. The training method also includes optimizing the imitated behavioral policy by minimizing a dissimilarity metric between the imitated behavioral policy and the human operator behavioral policy until a pre-defined stopping point is reached.

The training method can further comprise satisfying a focal loss function, or an otherwise parameterized loss function or reward function for class imbalance, that emphasizes training to handle the first and second entropic situations.

During data collection, the vehicle can receive an updated intended route that covers at least three seconds in the future trajectory. For instance, if the vehicle makes a wrong turn, the navigation system can recalculate the intended route. This prevents good driving from being considered seriously entropic due to a missed turn, particularly in behavioral cloning learning approaches. The updated intended route can also be used as part of the sample. The updated route can be flagged during data collection along with a sample selection to begin after the vehicle adopts the updated intended route, instead of straddling old and new intended routes. Alternatively, the intended route can change during the training sample.

The intended route can have an origin and a destination, even if predictions are made based on a next 3, 5, 10 or 20 seconds of intended route. Intentions more than 10 seconds out can be used when a lane change is required to prepare for a turn, to merge onto a highway or perform other longer-scale driving tasks and trajectories.

The data captured for the sequence of driving states can further include accelerometer measurements, such as G-forces. Analysis of accelerometer data can be used to automatically identify the first entropic situations. It also can be used to detect collisions that require human evaluation. The method can use probabilistic entropy in predictions by the conditional imitation learning model to identify the first entropic situations. Alternatively, it can use automated image analysis or human review of images to set the start and the end of the first entropic situations. The first entropic situations may include both corner and edge cases.

Adaptations in the methods described above make them applicable to autonomous delivery tasks using transporters.

Another implementation provides a method for building a training data set for training autonomous delivery tasks from at least a hundred hours of operator supervised driving data. This method includes collecting demonstration data from a fleet of human operator supervised transporters performing delivery tasks. This method also includes human operators in the fleet each supervising each of the transporters through a delivery task that has an intended route for at least the next 3 seconds. The transporter captures data for a sequence of driving states during the delivery task. The data includes at least video from one camera, at least one radar or LiDAR, location data from a GNSS receiver, velocity vector of travel, steering orientation, and accelerator/brakes actuation. In certain implementations, training data will further include information about the operator's eye movements using retinal tracking data. The hundred hours of operator supervised driving data including encounters with a distribution of delivery tasks can include driving tasks such as lane keeping, turning, arriving at a destination, navigating in the presence of moving and parked vehicles and pedestrians, obeying traffic signals, and avoiding collisions. First entropic situations organically arise during delivery tasks and are captured in the driving demonstration data.

One implementation of the disclosed method can be enhanced by creating and resolving second entropic situations. These situations can be created by having a confounding operator take over a part of the supervised driving and creating a second entropic situation for the human operator to resolve. Additionally, the system can flag the takeover and relinquishment of control by a confounding operator. The system can capture the driving data as the human operator extricates the transporter from the second entropic situation. This data can be used for training, validation, transfer learning, or other optimization processes.

Other implementations of the disclosed method further includes curating, from the captured driving data, a training set of at least 15 hours of driving data to imitate. Segments of the curating include selecting a representative sample of base routine driving situations with starts and ends; and identifying the first entropic situations and selecting a set of first entropic situations with starts and ends. When the method is enhanced, the segments further include locating the flagged second entropic situations and selecting a set of second entropic situations with starts and ends. The method can include excluding or labelling as negative examples driving tasks, if any, that produced an avoidable collision with a moving or stationary object.

Building of the training data set can be concluded by saving the curated driving data for use in training an end-to-end conditional imitation learning model to automate the vehicle.

As previously indicated, this method and other implementations of the technology disclosed can include one or more of the following features and/or features described in connection with additional methods disclosed. In the interest of conciseness, the combinations of features disclosed in this application are not individually enumerated and are not repeated with each base set of features.

The training data can be used during training and a further method that includes initializing an end-to-end conditional imitation learning model to automate the vehicle, wherein the end-to-end conditional imitation learning model is configured to imitate a behavioral policy of steering and accelerator/brakes actuation, defined by a probability distribution over actions and states in the curated training data set, such that the imitated behavioral policy is leveraged to predict a driving control action in response to (i) the present state, (ii) at least five earlier states over at least three seconds, and (iii) at least one intended route condition. This method further includes training the conditional imitation learning model with the curated training data set, such that the conditional imitation learning model is trained to imitate the behavioral policy of the human operators in the fleet. The training can further comprise optimizing the imitated behavioral policy by minimizing a dissimilarity metric between the imitated behavioral policy and the human operator behavioral policy until a pre-defined stopping point is reached.

The training also can comprise satisfying a focal loss penalty function that emphasizes training to handle the first and second entropic situations.

After initial training, confounding corner or edge cases, referred to as entropic situations, can be added to the training set during autonomous delivery tasks. This method includes further training the end-to-end neural network for autonomous delivery tasks from confounded autonomous driving data. The confounding autonomous driving data can be selected from 10, 20, 50, 100 or more hours of driving data. The method includes collecting, from a fleet of autonomous transporters demonstration data from autonomous delivery tasks. This includes autonomous transporters in the fleet each operating the conditional imitation learning model as an autonomous agent to supervise the transporter through a delivery task that has an intended route from an origin to a destination while the transporter captures data for a sequence of driving states. The data collected includes data from at least video from one camera, at least one radar or LiDAR, location data from a GNSS receiver, velocity vector of travel, steering orientation, and accelerator/brakes actuation. During autonomous delivery tasks, third entropic situations organically arise and are captured in the driving data. Collection of entropic situations can also be enhanced by taking over part of the autonomous delivery tasks to create and resolve fourth entropic situations. A confounding operator can take over the autonomous driving and create a fourth entropic situation for the autonomous agent to resolve. This system automatically flags the take over and relinquishment of control by the confounding operator and captures the driving data as the autonomous transporter extricates itself from the second difficult situation. The method further includes curating, from the confounded autonomous driving data, a further autonomous training set of at least 10 hours of driving data to imitate. The curating includes identifying the third entropic situations and selecting a set of third entropic situations with starts and ends. It includes locating the flagged fourth entropic situations, and optionally presenting these situations to a human. It further includes automatically or with human assistance selecting a set of fourth entropic situations with starts and ends for inclusion in training. Then, update training the conditional imitation learning model with the further curated autonomous training data set, such that the conditional imitation learning model training is reinforced by autonomous resolution of the fourth entropic situations.

During data collection, the delivery vehicle can receive an updated intended route that covers at least three seconds in the future trajectory. For instance, if the vehicle makes a wrong turn, the navigation system can recalculate the intended route. This prevents good driving from being considered seriously entropic due to a missed turn. The updated intended route can be used as part of the sample. The updated route can be flagged during data collection and a sample select to begin after the vehicle adopts the updated intended route, instead of straddling old and new intended routes. Alternatively, the intended route can change during the training process.

The intended route can have an origin and a destination, even if predictions are made based on a next 3, 5 or 10 seconds of intended route.

The data captured for the sequence of driving states during delivery tasks can further include accelerometer G-forces. Analysis of accelerometer data can be used to automatically identify the first entropic situations. it also can be used to detect collisions that require human evaluation. The method can use entropy between imitated behavior and the driving control action predicted by the conditional imitation learning model to identify the first entropic situations. Alternatively, it can use automated image analysis or human review of images to set the start and the end of the first entropic situations. The first entropic situations include corner and edge cases.

Many implementations of the present disclosure apply to autonomous delivery using trained machine learning algorithms.

Another implementation of the technology disclosed includes a computer-implemented method for autonomous delivery tasks by a transporter. This method includes recording environmental data for a sequence of driving states including at least video from a camera, returns from a radar or LiDAR, and location data from a GNSS receiver, wherein the camera, the radar or LiDAR, and the GNSS receiver are coupled to a processor carried by the transporter, the environmental data indicating a present state of a trajectory of the transporter. Autonomous control of the transporter includes repeatedly accessing an intended route for at least the next three seconds and repeatedly processing the present state and related data using an end-to-end neural network running on a processor to generate steering and speed control actions. Processing utilizes the environmental data for the present state, compressed embeddings from nine or more earlier states of the trajectory over at least three seconds, and the intended route. This data is used as input to the end-to-end neural network, which is previously trained to generate a compressed embedding of the processed data and to generate the steering and speed control actions from the compressed embedding. Method further includes repeatedly causing the transporter to execute a driving task applying the generated steering and speed control actions. The compressed embedding of the processed data for the present state is also stored to be provided as input to the end-to-end neural network to generate future responsive actions in response to future states of trajectories of the transporter.

The future state of the trajectory can be at least partially based on the generated action in response to the present state. The end-to-end neural network can be a conditional imitation learning model or another type of behavioral policy learning model.

The conditional imitation learning model can be trained using a plurality of demonstrations by a human operator. During training, a human operator demonstrates steering and acceleration actions in response to a state within the trajectory. The conditional imitation learning model is trained to learn a behavioral policy that best fits a ground truth probability distribution over responsive actions given states based on the human operator demonstrations.

The conditional imitation learning model can include a transformers. The transformer can be a memory-augmented transformer. In other implementation, a diffusion or variational autoencoder architecture is used. For a particular state in the trajectory the memory-augmented transformer produces a latent state output containing the compressed embedding of the particular state. The compressed embedding of the particular state is stored and provided as input for the processing of a future state by the memory-augmented transformer, such that the input for the memory-augmented transformer represents long-range dependencies within the trajectory. The memory-augmented transformer accesses the compressed embedding of the particular state to generate future responsive actions in view of a temporal dependency between sequential states of the trajectory.

The conditional imitation learning model can be trained to minimize a dissimilarity metric between the learned behavioral policy and the ground truth probability distribution over responsive actions given states. The dissimilarity metric can be augmented by a penalty term that penalizes error for minority class examples to a greater extent than majority class examples in training. The penalty term can be a focal loss focusing parameter.

In addition to methods, the technology disclosed can be practiced as an E2E conditional imitation learning model. Such models are computer-implemented. The model includes a stack of processors trained by imitation learning to control an autonomous vehicle. The processors run on processing hardware coupled to memory. The method further includes an input receiving processor that receives a video camera feed, a steering orientation feed, an accelerator/brake feed, a velocity vector feed, a current location feed, and an intended course feed. It optionally includes a radar or LiDAR image feed. Some implementations further comprise a first-in first-out frame buffer that holds at least nine prior frames of embeddings from a second stage processor, the frames spanning at least three seconds of travel by the autonomous vehicle. Alternatively, the buffer can hold two to 10 seconds of frames. In various implementations, the frame buffer can hold 5 to 20 frames, preferably coincident with the number of frames used by the second stage processor. A first stage processor embeds the video camera feed into an embedding space. The second stage processor further processes output from the first stage processor combined with the at least nine prior frames, the steering orientation feed, the accelerator/brake feed, the velocity vector feed, the current location feed, and the intended course feed for at least the next three seconds of operation. Of course, the number of frames and the duration of the intended course can vary. The second stage processor produces a frame output. A third classification processor that converts the frame output from the second stage into actuation signals directed to control the steering wheel and the accelerator/brake.

The first stage processor and the second stage processor can be transformers. The third classification processor is a fully connected neural network or multi-layer perceptron.

The production stack can be utilized during training as part of a trainer for an end-to-end conditional imitation learning model. The trainer adds to the production stack the training feedback then adjust model parameters. This includes an end-to-end conditional imitation learning trainer configured to imitate a behavioral policy of steering and accelerator/brakes actuation. The behavior policy is defined by a probability distribution over actions states in a curated training data set. The imitated behavioral policy is leveraged to predict the actuation signals directed to control the steering wheel and the accelerator/brake in response to the present frame. The end-to-end conditional imitation learning trainer updates and saves coefficients of the model, including coefficients of at least the second stage processor and the third classification processor.

The end-to-end conditional imitation learning trainer further can include a focal loss penalty function that emphasizes training to handle entropic situations. As with the production stack, the first stage processor and the second stage processor can be transformers, and the third classification processor can be a fully connected neural network or multi-layer perceptron.

The method above of generating a training set can also be practiced as a training set selector for building a training data set for training an end-to-end neural network for autonomous driving tasks from at least a million hours of operator supervised driving data. The raw operators supervised training data may be 100,000, or 50,000 hours, instead of 1,000,000 hours. The technology disclosed selects from driving data that includes demonstration data collected from a fleet of human operator supervised vehicles. Human operators in the fleet each supervise a vehicle through a driving task that has an intended route for at least the next 3 seconds. Even though the training only requires a brief intended route period of three, five or ten seconds, the fleet driving tasks may provide an extended route for a sequence of deliveries or pickups.

During driving tasks, the vehicle captures data for a sequence of driving states including at least video from one camera, location data from a GNSS receiver, a velocity vector of travel, steering wheel orientation, and accelerator/brakes actuation. During the operator supervised driving, the operator encounters a distribution of driving tasks while following the intended routes including lane keeping, turning, arriving at a destination, parking, navigating in the presence of moving and parked vehicles and pedestrians, obeying traffic signals, and avoiding collisions. While we list seven driving tasks the technology also can be applied to three, four, five tasks or an extended set of 15 or 20 tasks. The technology disclosed can be applied to tasks described in terms of ranges between any two of task counts, such as three to 20 tasks. In addition to driving data from routine driving tasks, first entropic situations organically arise during driving tasks and are captured in the driving data. The method can be enhanced when second entropic situations are created by imposing on a particular driving task a particular entropic situation for a particular human operator in the fleet to execute and resolve. the system can automatically flag at least starts of executing the second entropic situations, the system captures driving data as the particular human operator extricated the vehicle from the particular entropic situation.

Practicing the technology disclosed, the training set selector comprises a base situation selection processor and a first entropic situation selection processor. When the method is enhanced, the training set slacked or further includes a second entropic situation selection processor and optionally a manual curation GUI for collision situations. The base situation selection processor is configured to automatically select a representative sample of base routine driving situations with starts and ends. The representative sample can be automatically selected. The first selection processor is configured to automatically identify the first entropic situations and select a set of first entropic situations with starts and ends. The first entropic situations can be selected based on variance between predicted and imitated behavior. A second selection processor, when present, is configured to automatically locate the flagged second entropic situations and select a set of second entropic situations with starts and ends. The second entropic situations can be automatically selected or presented at a GUI for human selection. The manual curation GUI for collisions detected by accelerometer or other data is configured to interact with a user who excludes or labels as negative examples driving tasks, if any, that produced an avoidable collision with a moving or stationary object. This component is included with the system, at least during initial training stages but may become unnecessary as training progresses. The training set builder is configured to save the curated driving data for use in training an end-to-end conditional imitation learning model to automate the vehicle.

As previously indicated, this system implementation of the technology disclosed can include one or more of the features described above in connection with the methods disclosed. In the interest of conciseness, the combinations of features present in the methods are not repeated with each device but are instead repeated by reference as if set forth here.

The technology disclosed also includes validation of trained machine learning models for autonomous driving and delivery. One validation method utilizes a trained stack, generally as described above, combined with an onboard validation processor, and a central validation processor. For each vehicle in a fleet, a trained stack receives feeds, processing frames, and outputs steering and acceleration actuation signals. The onboard validation processor compares the actuation signals from the trained ML stack to operator generated actuation signals, detects deviations, and flags the deviations. The central validator receives the feeds, the actuation signals, and the flagged deviations. The central validation processor processes the flagged deviations in near real-time. By near real-time, we mean within one business day, or a time frame such as 36 to 80 hours. The method includes finding at least one instance in which operation of the vehicle in accordance with the actuation signals that gave rise to the flagged deviations would result in would have led to a virtual incident. This can be determined by image processing from a point of deviation going forward, such as going forward 5 to 10 seconds. The method includes reporting the virtual incident in the near real time for human devised corrective training. The human also can limit autonomous operation in any risky circumstances or alert copilot drivers to be alert for situations in which they should take over.

This method can be enhanced by equipping each vehicle in the fleet with an onboard incident sensor and providing a central incident calculator. The enhanced method further includes the onboard incident sensor detecting an incident from at least one vehicle in the fleet and flagging the incident. Next, the central incident calculator processes the flagged incident from the at least one vehicle in the near real-time. The central incident calculator finds at least one flagged incident in which the operator's actuations leading to the flagged incident and the trained ML stack's actuation signal coincided. The method includes reporting the flagged incident coincidence in the near real time as a candidate for human devised corrective training of previously learned training.

Another validation method is directed to when an operator is watching over autonomous driving or delivery tasks and is able to take over control. This additional validation method utilizes a training stack, generally as described above, combined with an onboard validation processor, and a central validation processor. For each vehicle in a fleet, a trained stack receives feeds, processing frames, and outputs steering and acceleration actuation signals. In this scenario in method, an operator observes and intervenes to take over control the operation of the vehicle or transporter. The onboard validation processor compares the actuation signals from the trained ML stack to operator intervention actuation signals, detects deviations, and flags the deviations. The central validator receives the feeds, the actuation signals, and the flagged deviations from at least one vehicle in the fleet. The central validation processor processing the flagged deviations in near real-time. By near real time we mean within one business day, or a time frame such as 36 to 80 hours. The method includes finding at least one instance in which operation of the vehicle in accordance with the actuation signals that gave rise to the flagged deviations would result in would have led to a virtual incident; and reporting the virtual incident in the near real time for human devised corrective training.

As above, this method can be enhanced by equipping each vehicle in the fleet with an onboard incident sensor and providing a central incident calculator. The enhanced method further includes the onboard incident sensor detecting an incident from at least one vehicle in the fleet and flagging the incident. then, the central incident calculator processing the flagged incident from the at least one vehicle in the near real time. The central incident calculator finds at least one flagged incident in which the operator's actuations leading to the flagged incident and the trained ML stack's actuation signal coincided. the method includes reporting the flagged incident coincidence in the near real time as a candidate for human devised corrective training of previously learned training.

Many implementations of the technology disclosed further comprise the trained autonomous driving model, such as a conditional imitation learning model as described in various examples herein, configured to include, or augment, one or more advanced driver assistance systems. These systems may include, at least, collision avoidance systems, automating braking features, adaptive cruise control, distracted driving warnings, maneuvering assistance features for specific tasks such as parking or lane changing, vehicle status and safety feedback, and so on. In some implementations, the assistance systems operate in a fully-autonomous mode. In other implementations, the assistance systems operate in a fully-manual mode. In yet other implementations, the assistance systems operate in both autonomous and manual modes of operation and may facilitate transitions between the two modes during semi-autonomous driving. Certain implementations may involve the training of one or more autonomous driving models, such as an imitation learning model, with operation-related data obtained during demonstration data collection, model training, model validation, model fine-tuning, expert feedback on model performance, and/or testing data after deployment. The training of models configured for advance driver assistance systems may leverage data obtained from a human or an autonomous robot operator. This data may be related to one time point or a plurality of time points. This data may also be related to operator action, driving state, or driving environment.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

One or more features of the implementations disclosed can be combined with any base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

The implementations disclosed may be implemented as a method, apparatus, system or article of manufacture using standard programming or engineering techniques to produce software, firmware, hardware, or any combination thereof. The term “article of manufacture” as used herein refers to code or logic implemented in hardware or stored computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices. One or more implementations of the technology disclosed, or elements thereof can be implemented in the form of a computer product including a non-transitory computer readable storage medium with computer usable program code for performing the method steps indicated. Furthermore, one or more implementations of the technology disclosed, or elements thereof can be implemented in the form of an apparatus including a memory and at least one processor that is coupled to the memory and operative to perform exemplary method steps. Yet further, in another aspect, one or more implementations of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The detailed description of some implementations will be better understood when read in conjunction with the appended drawings. To the extent that the figures illustrate diagrams of the functional blocks of various implementations, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be standalone programs, may be incorporated as subroutines in an operating system, may be functions in an installed software package, and the like. It should be understood that the various implementations are not limited to the arrangements and instrumentality shown in the drawings.

While the present invention is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims:

1. A computer-implemented method for building a training data set for training an end-to-end neural network for autonomous driving tasks from at least a hundred thousand hours of operator supervised driving data, the method including:
collecting, from a fleet of human operator supervised vehicles, demonstration data from driving tasks comprising:
human operators in the fleet each supervising the vehicle through a driving task that has an intended route for at least a next 3 seconds while the vehicle captures data for a sequence of driving states including at least video from one camera, location data from a GNSS receiver, a velocity vector of travel, steering wheel orientation, and accelerator/brakes actuation;
the hundred-thousand hours of operator supervised driving data including encounters with a distribution of driving tasks following the intended routes including lane keeping, turning, arriving at a destination, parking, navigating in proximity to moving and parked vehicles and pedestrians, obeying traffic signals, and avoiding collisions; and
first entropic situations organically arising during driving tasks and captured in the driving data;
directing part of the human operator supervised driving to create and resolve second entropic situations by imposing on a particular driving task a particular entropic situation for a particular human operator in the fleet to execute, flagging at least starts of executing the second entropic situations, and capturing the driving data as the particular human operator extricates the vehicle from the particular entropic situation;
curating, from the captured driving data, a training set of driving data to imitate, wherein the curating includes:
selecting a representative sample of base routine driving situations with starts and ends;
identifying the first entropic situations and selecting a set of first entropic situations with starts and ends;
locating the flagged second entropic situations and selecting a set of second entropic situations with starts and ends; and
excluding or labelling as negative examples driving tasks, if any, that produced an avoidable collision with a moving or stationary object; and
saving the curated driving data for use in training an end-to-end conditional imitation learning model to automate the vehicle.

2. The method of claim 1, further including:
initializing an end-to-end conditional imitation learning model to automate the vehicle, wherein the end-to-end conditional imitation learning model is configured to imitate a behavioral policy of steering and accelerator/brakes actuation, defined by a probability distribution of actions given states in the curated training data set, whereby the imitated behavioral policy is leveraged to predict a driving control action in response to (i) a present state including a visual image, location, intended path, and steering and accelerator/brake actuation, (ii) a compressed representation from at least five earlier states over at least three seconds, and (iii) at least one intended route condition; and
training the conditional imitation learning model with the curated training data set to imitate the behavioral policy of the human operators in the fleet,
wherein the training further comprises optimizing the imitated behavioral policy by minimizing a dissimilarity metric between the imitated behavioral policy and the human operator behavioral policy until a pre-defined stopping point is reached.

3. The method of claim 2, wherein the training further comprises satisfying a focal loss function that emphasizes training to handle the first and second entropic situations.

4. The method of claim 1, further including:
the vehicle receiving an updated intended route for the at least three seconds in at least one sample in the selected set of driving data to imitate; and
the updated intended route being used as part of the sample beginning when the vehicle adopted the updated intended route,
whereby the intended route changed during the training sample.

5. The method of claim 1, further including the intended route having an origin to a destination.

6. The method of claim 1, wherein the data captured for the sequence of driving states further includes accelerometer G-forces.

7. The method of claim 6, further including using accelerometer analysis to identify the first entropic situations. (Original) The method of claim 1, further including using entropy between imitated behavior and the driving control action predicted by the conditional imitation learning model to identify the first entropic situations.

9. A computer-implemented method for building a training data set for training autonomous delivery tasks from at least a hundred hours of operator supervised driving data, the method including:
collecting, from a fleet of human operator supervised transporters demonstration data from delivery tasks comprising:
human operators in the fleet each supervising the transporter through a delivery task that has an intended route for at least the next 3 seconds while the transporter captures data for a sequence of driving states including at least video from one camera, returns from at least one radar or LiDAR, location data from a GNSS receiver, velocity vector of travel, steering orientation, and accelerator/brakes actuation;
the hundred hours of operator supervised driving data including encounters with a distribution of delivery tasks including lane keeping, turning, arriving at a destination, navigating in the presence of moving and parked vehicles and pedestrians, obeying traffic signals, and avoiding collisions;
first entropic situations organically arising during delivery tasks and captured in the driving data; and
directing part of the human operator supervised driving to create and resolve second entropic situations by having a confounding operator take over the supervised driving and creating a second entropic situation for the human operator to resolve, flagging take over and relinquishment of control by the confounding operator, and capturing the driving data as the human operator extricates the transporter from the second entropic situation;
curating, from the captured driving data, a training set of at least 15 hours of driving data to imitate, wherein the curating includes:
selecting a representative sample of base routine driving situations with starts and ends;
identifying the first entropic situations and selecting a set of first entropic situations with starts and ends;
locating the flagged second entropic situations and selecting a set of second entropic situations with starts and ends; and
excluding or labelling as negative examples driving tasks, if any, that produced an avoidable collision with a moving or stationary object; and
saving the curated driving data for use in training an end-to-end conditional imitation learning model to automate the vehicle.

10. The method of claim 9, further including:
initializing an end-to-end conditional imitation learning model to automate the vehicle, wherein the end-to-end conditional imitation learning model is configured to imitate a behavioral policy of steering and accelerator/brakes actuation, defined by a probability distribution over actions and states in the curated training data set, such that the imitated behavioral policy is leveraged to predict a driving control action in response to (i) the present state, (ii) at least five earlier states over at least three seconds, and (iii) at least one intended route condition; and
training the conditional imitation learning model with the curated training data set, such that the conditional imitation learning model is trained to imitate the behavioral policy of the human operators in the fleet,
wherein the training further comprises optimizing the imitated behavioral policy by minimizing a dissimilarity metric between the imitated behavioral policy and the human operator behavioral policy until a pre-defined stopping point is reached.

11. The computer-implemented method of claim 9, with further training the end-to-end neural network for autonomous delivery tasks from at least a hundred hours of confounded autonomous driving data, the method including:
collecting, from a fleet of autonomous transporters demonstration data from autonomous delivery tasks comprising:
autonomous transporters in the fleet each operating the conditional imitation learning model as an autonomous agent to supervise the transporter through a delivery task that has an intended route from an origin to a destination while the transporter captures data for a sequence of driving states including at least video from one camera, returns from at least one radar or LiDAR, location data from a GNSS receiver, velocity vector of travel, steering orientation, and accelerator/brakes actuation;
third entropic situations organically arising during delivery tasks and captured in the driving data;
taking over part of the delivery tasks to create and resolve fourth entropic situations by having the confounding operator take over the autonomous driving and creating a fourth entropic situation for the autonomous agent to resolve, flagging take over and relinquishment of control by the confounding operator, and capturing the driving data as the autonomous transporter extricates the itself from the second difficult situation;
curating, from the confounded autonomous driving data, a further autonomous training set of at least 10 hours of driving data to imitate, wherein the curating includes:
identifying the third entropic situations and selecting a set of third entropic situations with starts and ends;
locating the flagged fourth entropic situations, human and selecting a set of fourth entropic situations with starts and ends; and
update training the conditional imitation learning model with the further curated autonomous training data set, such that the conditional imitation learning model training is reinforced by autonomous resolution of the fourth entropic situations.

12. The method of claim 9, further including:
the vehicle receiving an updated intended route for the at least three seconds in at least one sample in the selected set of driving data to imitate; and
the updated intended route being used as part of the sample beginning when the vehicle adopted the updated intended route,
whereby the intended route changed during the training sample.

13. An end-to-end conditional imitation learning model, including a stack of processors trained by imitation learning to control an autonomous vehicle, the processors running on processing hardware coupled to memory, further including:
an input receiving processor that receives
a video camera feed,
a steering orientation feed,
an accelerator/brake feed,
a velocity vector feed,
a current location feed, and
an intended course feed;
a first-in first-out frame buffer that holds at least nine prior frames of embeddings from a second stage processor, the frames spanning at least three seconds of travel by the autonomous vehicle
a first stage processor that embeds the video camera feed into an embedding space;
the second stage processor that further processes output from the first stage processor combined with
the at least nine prior frames,
the steering orientation feed,
the accelerator/brake feed,
the velocity vector feed,
the current location feed, and
the intended course feed for at least a next three seconds of operation and produces a frame output; and
a third classification processor that converts the frame output from the second stage into actuation signals directed to control the steering wheel and the accelerator/brake.

14. The trainer of claim 13, wherein the first stage processor and the second stage processor are transformers, and the third classification processor is a fully connected neural network or multi-layer perceptron.

15. The trainer of claim 13, wherein the input receiving processor further receive a radar or LiDAR feed and the first stage processor inputs include the radar or LiDAR feed.

16. A training set selector for building a training data set for training an end-to-end neural network for autonomous driving tasks from at least a 100,000 hours of operator supervised driving data,
wherein the driving data includes demonstration data collected from a fleet of human operator supervised vehicles comprises:
human operators in the fleet each supervising the vehicle through a driving task that has an intended route for at least the next 3 seconds while the vehicle captures data for a sequence of driving states including at least video from one camera, location data from a GNSS receiver, a velocity vector of travel, steering wheel orientation, and accelerator/brakes actuation;
the 100,000 hours of operator supervised driving data including encounters with a distribution of driving tasks following the intended routes including lane keeping, turning, arriving at a destination, parking, navigating in the presence of moving and parked vehicles and pedestrians, obeying traffic signals, and avoiding collisions; and
first entropic situations organically arising during driving tasks and captured in the driving data;
second entropic situations created by imposing on a particular driving task a particular entropic situation for a particular human operator in the fleet to execute and resolve, with flagged at least starts of executing the second entropic situations, and captured driving data as the particular human operator extricated the vehicle from the particular entropic situation;
wherein the training set selector comprises:
a base situation selection processor configured to automatically select a representative sample of base routine driving situations with starts and ends;
a first selection processor configured to automatically identify the first entropic situations and select a set of first entropic situations with starts and ends;
a second selection processor configured to automatically locate the flagged second entropic situations and select a set of second entropic situations with starts and ends; and
a manual curation GUI configured to interact with a user who excludes or labels as negative examples driving tasks, if any, that produced an avoidable collision with a moving or stationary object; and
a training set builder configured to save the curated driving data for use in training an end-to-end conditional imitation learning model to automate the vehicle.

17. A vehicle operation validator method, utilizing the trained stack of claim 13, an onboard validation processor, and a central validation processor, including for each vehicle in a fleet:
the trained stack receiving the feeds, processing the frames, and outputting steering and acceleration actuation signals;
the onboard validation processor comparing the actuation signals from the trained ML stack to operator generated actuation signals, detecting deviations and flagging the deviations;
the central validator receiving the feeds, the actuation signals, and the flagged deviations; and
the central validation processor processing the flagged deviations in near real time; finding at least one instance in which operation of the vehicle in accordance with the actuation signals that gave rise to the flagged deviations would result in would have led to a virtual incident; and reporting the virtual incident in the near real time for human devised corrective training.

18. The vehicle operation validator method of claim 17, further utilizing an onboard incident sensor on each vehicle in the fleet and a central incident calculator, further including:
the onboard incident sensor detecting an incident from at least one vehicle in the fleet and flagging the incident;
the central incident calculator processing the flagged incident from the at least one vehicle in the near real time; finding at least one flagged incident in which the operator's actuations leading to the flagged incident and the trained ML stack's actuation signal coincided; and reporting the flagged incident coincidence in the near real time as a candidate for human devised corrective training.

19. A vehicle operation validator method, utilizing the trained stack of claim 13, an onboard validation processor, and a central validation processor, including for each vehicle in a fleet:
the trained stack receiving the feeds, processing the frames, and outputting the actuation signals;
an operator observing and intervening to take over control the operation of the vehicle;
the onboard validation processor comparing the actuation signals from the trained ML stack to operator intervention actuation signals, detecting deviations and flagging the deviations;
the central validator receiving the feeds, the actuation signals and the flagged deviations from at least one vehicle in the fleet; and
the central validation processor processing the flagged deviations in near real time; finding at least one instance in which operation of the vehicle in accordance with the actuation signals that gave rise to the flagged deviations would result in would have led to a virtual incident; and reporting the virtual incident in the near real time for human devised corrective training.

20. The vehicle operation validator method of claim 19, further utilizing an onboard incident sensor on each vehicle in the fleet and a central incident calculator, further including:
the onboard incident sensor detecting an incident from at least one vehicle in the fleet and flagging the incident;
the central incident calculator processing the flagged incident from the at least one vehicle in the near real time; finding at least one flagged incident in which the operator's actuations leading to the flagged incident and the trained ML stack's actuation signal coincided; and reporting the flagged incident coincidence in the near real time as a candidate for human devised corrective training.

21. A vehicle operation validator method, utilizing the trained stack of claim 13, an onboard validation processor, and a central validation processor, including for each vehicle in a fleet:
the trained stack receiving the feeds, processing the frames, and outputting the actuation signals;
an operator at least once taking over control, creating an entropic situation, and relinquishing control, producing a flagged deviation;
the onboard validation processor comparing the actuation signals from the trained ML stack to operator generated actuation signals, detecting deviations and flagging the deviations;
the central validator receiving the feeds, the actuation signals, the flagged deviations and the flagged incident from at least one vehicle in the fleet;
the central validation processor processing the flagged deviations in near real time; finding at least one instance in which operation of the vehicle in accordance with the actuation signals that gave rise to the flagged deviations would result in would have led to a virtual incident; and reporting the virtual incident in the near real time as a candidate for human devised corrective training.

22. The vehicle operation validator method of claim 21, further utilizing an onboard incident sensor on each vehicle in the fleet and a central incident calculator, further including:
the onboard incident sensor detecting an incident from at least one vehicle in the fleet and flagging the incident;
the central incident calculator processing the flagged incident from the at least one vehicle in the near real time; finding at least one flagged incident in which the operator's actuations leading to the flagged incident and the trained ML stack's actuation signal coincided; and reporting the flagged incident coincidence in the near real time as a candidate for human devised corrective training.

23. A trainer for the end-to-end conditional imitation learning model of claim 13, further including:
an end-to-end conditional imitation learning trainer configured to imitate a behavioral policy of steering and accelerator/brakes actuation, defined by a probability distribution over actions states in a curated training data set, such that the imitated behavioral policy is leveraged to predict the actuation signals directed to control the steering wheel and the accelerator/brake in response to the present frame, wherein the end-to-end conditional imitation learning trainer updates and saves coefficients of the model, including coefficients of at least the second stage processor and the third classification processor.
